(19) United States
(12) Patent Application Publication
(10) Pub. No.: US 2022/0198246 A1
(43) Pub. Date: Jun. 23, 2022

(54) VARIATIONAL ANNEALING

(71) Applicant: Vector Institute, Toronto (CA)

(72) Inventors: Mohamed HIBAT ALLAH, Toronto (CA); Estelle M. INACK, Waterloo (CA); Juan Felipe CARRASQUILLA ALVAREZ, Toronto (CA)

(21) Appl. No.: 17/547,690

(22) Filed: Dec. 10, 2021

Related U.S. Application Data
(60) Provisional application No. 63/123,917, filed on Dec. 10, 2020.

(51) Int. Cl. G06N 3/04; G06F 17/18

(52) U.S. Cl. CPC G06N 3/0472; G06N 3/0445; G06F 17/18

(57) ABSTRACT

A method, device, and computer-readable medium for solving optimization problems using a variational formulation of classical or quantum annealing. The input states and the parameters of the variational ansatz are initialized, and variational classical or quantum annealing algorithm is applied until a desirable output is obtained. By generalizing the target distribution with a parameterized model, an annealing framework based on the variational principle is used to search for groundstate solutions. Modern autoregressive models such as recurrent neural networks may be used for parameterizations. The method may be implemented on spin glass Hamiltonians.

### RELATED APPLICATION DATA

This application claims priority to U.S. Provisional Patent Application No. 63/123,917, filed Dec. 10, 2020.

### TECHNICAL FIELD

The present application generally relates to quantum computing, and in particular to the variational emulation of both classical and quantum annealing using machine learning.

### BACKGROUND

Many combinatorial optimization problems relevant to diverse fields such as computer science, computational biology and physics can be encoded into an energy functional whose lowest state encodes the solution of the problem. Heuristic methods have been used to approximate solutions to those problems. One such heuristic method is simulated annealing, a method that uses thermal fluctuations to explore the landscape describing the optimization problem in the search for solutions. Its quantum counterpart, quantum annealing, instead uses quantum tunneling through energy barriers to find the solution of the optimization problem.

### SUMMARY

The present disclosure relates to methods, devices, and computer-readable media for finding solutions to optimization tasks via in-silico numerical simulations. In particular, the disclosure describes methods, devices, and computer-readable media for solving optimization problems using classical computing hardware, as opposed to quantum computing hardware (i.e. quantum computers). Examples described herein may provide more efficient and/or more accurate solutions to optimization problems relative to existing approaches implemented using classical computing hardware. Furthermore, examples described herein may provide benchmarks for solving such problems, which can be used to measure the efficiency and/or accuracy of quantum tunneling-based approaches implemented using quantum computing hardware.

In a first aspect, the present disclosure provides a method for providing a solution to an optimization task using a variational emulation of annealing, the solution comprising a plurality of values for a respective plurality of parameters. The method comprises a number of steps. A plurality of initial input values is obtained. A variational ansatz is obtained, comprising a plurality of initial values for the plurality of parameters. The following two steps are repeated one or more times: performing an annealing step while maintaining the values of the plurality of parameters, and performing a training step to modulate the values of the plurality of parameters according to a cost function, thereby generating a plurality of trained values of the respective plurality of parameters. The plurality of trained values have a lower cost, according to the cost function, than a cost of the values of the plurality of parameters prior to the modulation.

In a further aspect, the present disclosure provides a device comprising a processor and a memory. The memory stores instructions that, when executed by the processor, cause the device to provide a solution to an optimization task using a variational emulation of annealing, the solution comprising a plurality of values for a respective plurality of parameters. A plurality of initial input values is obtained. A variational ansatz is obtained, comprising a plurality of initial values for the plurality of parameters. The following two steps are repeated one or more times: performing an annealing step while maintaining the values of the plurality of parameters, and performing a training step to modulate the values of the plurality of parameters according to a cost function, thereby generating a plurality of trained values of the respective plurality of parameters. The plurality of trained values have a lower cost, according to the cost function, than a cost of the values of the plurality of parameters prior to the modulation.

In a further aspect, the present disclosure provides a non-transitory computer readable medium storing instructions that, when executed by a processor of a device, cause the device to provide a solution to an optimization task using a variational emulation of annealing, the solution comprising a plurality of values for a respective plurality of parameters. A plurality of initial input values is obtained. A variational ansatz is obtained, comprising a plurality of initial values for the plurality of parameters. The following two steps are repeated one or more times: performing an annealing step while maintaining the values of the plurality of parameters, and performing a training step to modulate the values of the plurality of parameters according to a cost function, thereby generating a plurality of trained values of the respective plurality of parameters. The plurality of trained values have a lower cost, according to the cost function, than a cost of the values of the plurality of parameters prior to the modulation.

In some examples, the annealing step comprises changing a temperature parameter of the cost function.

In some examples, the variational emulation of annealing is variational emulation of classical annealing, and the cost function comprises a variational free energy function.

In some examples, the annealing step comprises changing a driving coupling of the cost function.

In some examples, the variational emulation of annealing is variational emulation of quantum annealing, and the cost function comprises a variational energy function.

In some examples, positive wavefunctions ansatzes are used to implement stoquastic drivers.

In some examples, complex wavefunctions ansatzes are used to implement non-stoquastic drivers.

In some examples, the annealing step comprises: changing a driving coupling of the ansatz, and changing a fictitious temperature parameter of the cost function.

In some examples, the variational ansatz comprises an autoregressive neural network.

In some examples, the autoregressive neural network encodes one or more of the following: the locality of the optimization task, the connectivity of the optimization task, and the uniformity or nonuniformity of the optimization task.

In some examples, the method further comprises estimating a number of solutions of the optimization problem by calculating a residual entropy.

In some examples, the training step comprises performing gradient descent on the plurality of parameters based on the cost function.

In some examples, the method further comprises, after repeating the annealing step and training step one or more times, storing the variational ansatz for future sampling.

In some examples, the variational ansatz comprises an autoregressive neural network, and the future sampling comprises using the variational ansatz as an on-demand sampler for generating solutions of the optimization task.

In some examples, the variational ansatz comprises an autoregressive neural network, and the future sampling comprises using the variational ansatz as an on-demand sampler for generating solutions of a different optimization task.

In some examples, the method further comprises, after repeating the annealing step and training step one or more times, using the values of the plurality of parameters as an input to train a neural network to perform an optimization task that the neural network was not previously trained to perform.

In some examples, the training step comprises: setting a temperature parameter of the cost function to zero, and setting a transverse field parameter of the cost function to zero.

In some examples, the variational ansatz comprises one of the following: a mean field model, a tensor network, or a non-autoregressive artificial neural network.

In some examples, the variational ansatz encodes one or more of the following: the locality of the optimization task, the connectivity of the optimization task, and the uniformity or nonuniformity of the optimization task.

Some examples described herein may exhibit one or more advantages over existing approaches to simulated or quantum annealing.

Existing approaches, such as simulated annealing and its quantum counterpart, simulated quantum annealing, are traditionally implemented via Markov chain Monte Carlo. When deployed to solve challenging optimization problems, they often display slow convergence to optimal solutions. In contrast, some example embodiments described herein make use of autoregressive models as variational ansatzes. Thus, examples described herein may allow the use of so-called autoregressive sampling. This sampling technique allows the drawing of independent samples, and hence helps to avoid critical slowing down, which is a limiting factor in the Markov-chain sampling used by existing approaches. Autoregressive sampling may be particularly useful when dealing with disordered systems, such as spin glasses and protein systems, that require very long Markov chains to sample the multi-modal probability distribution that describes their equilibrium state.

For example, when deployed to solve certain classes of hard optimization problems, some examples described herein may obtain solutions that are orders of magnitudes more accurate than existing approaches such as simulated annealing and simulated quantum annealing.

In addition, compared to existing heuristic approaches, some embodiments described herein can give an estimate of how many solutions an optimization problem has. This is done by estimating the value of the entropy at zero temperature.

Furthermore, through the use of the sign-problem-free variational Monte Carlo method, some implementations of the methods in this embodiment can emulate quantum annealing with non-stoquastic drivers at moderately large system sizes, thus providing a useful tool to benchmark the next generation of quantum annealing devices which implement non-stoquastic drivers.

It will be appreciated that some of the examples described herein may be implemented using quantum computing hardware instead of classical computing hardware.

### BRIEF DESCRIPTION OF THE DRAWINGS

Reference will now be made, by way of example, to the accompanying drawings which show example embodiments of the present application, and in which:

FIG. 1 shows a schematic illustration of the space of probability distributions visited during simulated annealing, according to example embodiments disclosed herein;

FIG. 2A shows pictorial graphs of the variational free energy F across parameters M for four steps of an example variational classical annealing (VCA) algorithm, according to example embodiments disclosed herein;

FIG. 2B shows pictorial graphs of the variational free energy F over time t for four steps of an example variational quantum annealing (VQA) algorithm, according to example embodiments disclosed herein;

FIG. 3A shows a flowchart of the steps of the example variational annealing algorithm of FIGS. 2A and 2B;

FIG. 3B shows a block diagram of an example 1D recurrent neural network (RNN) ansatz used for both VCA and VQA, according to example embodiments disclosed herein;

FIG. 3C shows a graph of the residual energy per site ∈ᵣₑₛ/N vs. the number of annealing steps N_{annealing} for both VQA and VCA implemented as variational neural annealing on random continuous coupling Ising chains, according to example embodiments disclosed herein;

FIG. 4A shows a block diagram of an example RNN encoding the structure of the 2D geometry of the Edward-Anderson (EA) model, according to example embodiments disclosed herein;

FIG. 4B shows a graph of the residual energy per site ∈ᵣₑₛ/N vs. the number of annealing steps N_{annealing} of the annealing results obtained for VCA and VQA using the RNN of FIG. 4A with N=10×10, and results of the residual energy per site vs. the number of gradient descent steps Nₛₜₑₚₛ of the classical-quantum optimization (CQO) using the RNN of FIG. 4A;

FIG. 4C shows a graph of the residual energy per site ∈ᵣₑₛ/N vs. the number of annealing steps N_{annealing} of the annealing results obtained for simulated annealing (SA), simulated quantum annealing (SQA), and VCA using the RNN of FIG. 4A;

FIG. 5 shows a block diagram of a dilated RNN ansatz structured so that spins are connected to each other, according to example embodiments disclosed herein;

FIG. 6A shows a graph of the residual energy per site ∈ᵣₑₛ/N vs. the number of annealing steps N_{annealing} of the annealing results obtained for SA, SQA, and VCA using a Sherrington-Kirkpatrick (SK) model with N=100 spins for fully-connected spin glasses, according to example embodiments disclosed herein;

FIG. 6B shows a graph of the residual energy per site ∈ᵣₑₛ/N vs. the number of annealing steps N_{annealing} of the annealing results obtained for SA, SQA, and VCA using a Wishart planted ensemble (WPE) model with N=32 spins and a=0.5 for fully-connected spin glasses, according to example embodiments disclosed herein;

FIG. 6C shows a graph of the residual energy per site ∈ᵣₑₛ/N vs. the number of annealing steps N_{annealing} of the annealing results obtained for SA, SQA, and VCA using a WPE model with N=32 spins and α=0.25 for fully-connected spin glasses, according to example embodiments disclosed herein;

FIG. 6D shows a residual energy histogram for the model of FIG. 6A;

FIG. 6E shows a residual energy histogram for the model of FIG. 6B;

FIG. 6F shows a residual energy histogram for the model of FIG. 6C;

FIG. 7A shows a graph of the variational energy of RNN wave function against the transverse magnetic field with plurality of parameters A initialized using the parameters optimized in the previous annealing step, with random parameter reinitialization, and as the exact energy obtained from exact diagonalization, according to example embodiments disclosed herein;

FIG. 7B shows a graph of the residual energy of the RNN wave function vs. the transverse field p, showing the residual energy and the gap within error bars, according to example embodiments disclosed herein;

FIG. 7C shows the variational free energy vs. temperature T for a VCA run, with λ initialized using the parameters optimized in the previous annealing step, and with random reinitialization and the exact free energy according to example embodiments disclosed herein;

FIG. 8 shows a graph of residual energy per site ∈ᵣₑₛ/N vs. N_{annealing} for both VQA and VCA on random discrete coupling Ising chains, according to example embodiments disclosed herein;

FIG. 9A shows a graph of residual energy ∈ᵣₑₛ/N vs. N_{annealing} for SA, SQA and VCA on a single instance of the EA model with system size (60×60), according to example embodiments disclosed herein;

FIG. 9B shows a graph of residual energy ∈ᵣₑₛ/N vs. N_{annealing} for SA, SQA and VCA on a single instance of the EA model with system size (60×60), according to example embodiments disclosed herein;

FIG. 9C shows a plot of the two principal components X₁ and X₂ after performing principal component analysis (PCA) on 50000 configurations obtained from a RNN, at the end of a VCA protocol when applied to the SK model with N=100 spins as in FIG. 9B for N_{annealing}=10⁵, according to example embodiments disclosed herein;

FIG. 9D shows a histogram of the probability of success on the 25 instances of the SK model used in FIG. 6A;

FIG. 9E shows a histogram of the probability of success on the 25 instances of the WPE model used in FIG. 6B;

FIG. 9F shows a histogram of the probability of success on the 25 instances of the WPE model used in FIG. 6C;

FIG. 10A shows a graph of the energy variance per site σ² against the number of gradient descent steps for a vanilla RNN and a tensorized RNN in a task of finding the ground state of the uniform ferromagnetic Ising chain (i.e., J_{i,i+1}=1) with N=100 spins at the critical point, according to example embodiments disclosed herein;

FIG. 10B shows a graph of the energy variance per site σ² against the number of gradient descent steps for models using site-dependent parameters vs. site-independent parameters in the task of FIG. 10A;

FIG. 10C shows a graph of the free energy variance per site σ² against the number of gradient descent steps for a dilated RNN vs. a tensorized RNN in the task of finding the minimum of the free energy of the Sherrington-Kirkpatrick model with N=20 sites and at temperature T=1, according to example embodiments disclosed herein;

FIG. 11 is a flowchart showing steps of an example method for performing variational annealing for optimization, according to example embodiments disclosed herein;

FIG. 12 is a flowchart showing steps of an example method for performing in detail variational annealing in a classical or quantum fashion, according to example embodiments disclosed herein;

FIG. 13 is a flowchart showing steps of an example method for performing a training/optimization step in a variational annealing process, according to example embodiments disclosed herein; and

FIG. 14 is a block diagram of an example processing system for performing variational classical or quantum annealing for optimization, according to example embodiments disclosed herein.

Similar reference numerals may have been used in different Figures to denote similar components.

### DETAILED DESCRIPTION

The present disclosure describes examples of methods, devices, and computer-readable media for solving optimization tasks by using a variational emulation of the annealing paradigm either in its classical or its quantum formulation. In some embodiments, an appropriate cost function is used that encodes the optimization problem, and whose adequate minimization throughout the annealing process may increase the efficiency of the described methods, provided a favourable annealing schedule is utilized.

Detailed Description of Tested Embodiments, Methods, and Results

The following section of the specification provides details of the research underlying example embodiments described herein, as performed by researchers including the inventors named herein. Some embodiments described herein, and the results of research and testing, are described by the researchers, Hibat-Allah, M., Inack, E., Wiersema, R., Melko, R., and Carrasquilla, J., in “Variational Neural Annealing”, arXiv:2101.10154 (2021), available at https://arxiv.org/abs/2101.10154, which is hereby incorporated by reference in its entirety.

Introduction

Many important challenges in science and technology can be cast as optimization problems. When viewed in a statistical physics framework, these can be tackled by simulated annealing, where a gradual cooling procedure helps search for groundstate solutions of a target Hamiltonian. While potentially powerful, simulated annealing is known to have prohibitively slow sampling dynamics when the optimization landscape is rough or glassy. However, as described herein, by generalizing the target distribution with a parameterized model, an analogous annealing framework based on the variational principle can be used to search for groundstate solutions. Modern autoregressive models such as recurrent neural networks (RNNs) provide ideal parameterizations since they can be exactly sampled without slow dynamics even when the model encodes a rough landscape. This method is implemented in the classical and quantum settings on several prototypical spin glass Hamiltonians, with findings that on average, example methods described herein significantly outperform traditional simulated annealing in the asymptotic limit, illustrating the potential power of this yet unexplored route to optimization.

A wide array of complex combinatorial optimization problems can be reformulated as finding the lowest energy configuration of an Ising Hamiltonian of the form:

H_{target}=−Σ_{i<j}Jᵢⱼσᵢσⱼ−Σᵢ₌₁^{N}hᵢσ_{i,} (1)

where σᵢ=±1 are spin variables defined on the N nodes of a graph. The topology of the graph together with the couplings Jᵢᵢ and fields hᵢ uniquely encode the optimization problem, and its solutions correspond to configurations {σᵢ} that minimize H_{target}. While the lowest energy states of certain families of Ising Hamiltonians can be found with modest computational resources, most of these problems are hard to solve and belong to the non-deterministic polynomial time (NP)-hard complexity class.

Various heuristics have been used over the years to find approximate solutions to these NP-hard problems. A notable example is simulated annealing (SA), which mirrors the analogous annealing process in materials science and metallurgy where a solid is heated and then slowly cooled down to its lowest energy and most structurally stable crystal arrangement. In addition to providing a fundamental connection between the thermodynamic behavior of real physical systems and complex optimization problems, simulated annealing has enabled scientific and technological advances with far-reaching implications in areas as diverse as operations research, artificial intelligence, biology, graph theory, power systems, quantum control, circuit design among many others.

The paradigm of annealing has been so successful that it has inspired intense research into its quantum extension, which requires quantum hardware to anneal the tunneling amplitude, and can be simulated in an analogous way to SA.

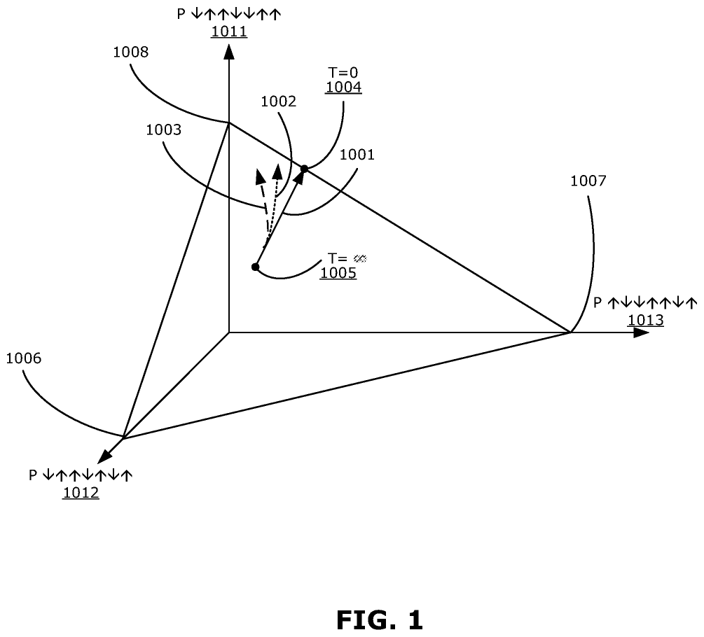

The SA algorithm explores an optimization problem's energy landscape via a gradual decrease in thermal fluctuations generated by the Metropolis-Hastings algorithm. The procedure stops when all thermal kinetics are removed from the system, at which point the solution to the optimization problem is expected to be found. While an exact solution to the optimization problem is always attained if the decrease in temperature is arbitrarily slow, a practical implementation of the algorithm must necessarily run on a finite time scale. As a consequence, the annealing algorithm samples a series of effective, quasi-equilibrium distributions close but not exactly equal to the stationary Boltzmann distributions targeted during the annealing (as shown in FIG. 1, described below). This naturally leads to approximate solutions to the optimization problem, whose quality depends on the interplay between the problem complexity and the rate at which the temperature is decreased.

In this disclosure, an alternative route is offered to solving optimization problems of the form of Eq. (1), called variational neural annealing. Here, the conventional simulated annealing formulation is substituted with the annealing of a parameterized model. Namely, instead of annealing and approximately sampling the exact Boltzmann distribution, this approach anneals a quasi-equilibrium model, which must be sufficiently expressive and capable of tractable sampling. Fortunately, suitable models have recently been developed. In particular, autoregressive models combined with variational principles have been shown to accurately describe the equilibrium properties of classical and quantum systems. Here, variational neural annealing is implemented using recurrent neural networks (RNN), and show that they offer a powerful alternative to conventional SA and its analogous quantum extension, i.e., simulated quantum annealing (SQA). This powerful and unexplored route to optimization is illustrated in FIG. 1, where a variational neural annealing trajectory 1002 provides a more accurate approximation to the ideal trajectory 1001 than a conventional SA run 1003.

FIG. 1 shows a schematic illustration of the space of probability distributions visited during simulated annealing defined by axes P ⬇⬆⬆⬇⬇⬆⬆ 1011, P ⬇⬆⬆⬇⬆⬇⬆ 1012, and P ⬆⬇⬇⬆⬆⬇⬆ 1013. An arbitrarily slow SA visits a series of Boltzmann distributions starting at the high temperature 1005 (e.g. T=∞) and ending in the T=0 Boltzmann distribution 1004, where a perfect solution to an optimization problem is reached. These solutions are found either at the edge or a corner (for non-degenerate problems) of the standard probabilistic simplex (triangular plane defined by points 1006, 1007, 1008). A practical, finite-time SA trajectory 1003, as well as a variational classical annealing trajectory 1002, deviate from the trajectory of exact Boltzmann distributions. The temperature is high at the high temperature 1005 and colder the farther one moves away from the high temperature 1005 within the triangular plane.

Variational Classical and Quantum Annealing

The variational approach to statistical mechanics is considered, where a distribution p_{λ}(σ) defined by a set of variational parameters λ is optimized to reproduce the equilibrium properties of a system at temperature T. The first variational neural annealing algorithm is referred to herein as “variational classical annealing” (VCA).

The VCA algorithm searches for the ground state of an optimization problem by slowly annealing the model's variational free energy

F_{λ}(t)= [symbol] H_{target} [symbol] _{λ}−T(t)S_{classical}(p_{λ}) (2)

from a high temperature to a low temperature. The quantity F_{λ}(t) provides an upper bound to the true instantaneous free energy and can be used at each annealing stage to update λ through gradient-descent techniques. The brackets < . . . >_{λ} denote ensemble averages over p_{λ}(σ). The von Neumann entropy is given by

S_{classical}(p_{λ})=−Σ_{σ}p_{λ} (σ)log (p_{λ}(σ)), (3)

where the sum runs over all possible configurations {σ}. In this setting, the temperature is decreased linearly from T₀ to 0, i.e., T(t)=T₀(1−t), where t ∈ [0,1], which follows the traditional implementation of SA.

In order for VCA to succeed, it requires parameterized models that enable the estimation of entropy, Eq. (3), without incurring expensive calculations of the partition function. In addition, it is anticipated that hard optimization problems will induce a complex energy landscape into the parameterized models and an ensuing slowdown of their sampling via Markov chain Monte Carlo. These issues preclude un-normalized models such as restricted Boltzmann machines, where sampling relies on Markov chains and whose partition function is intractable to evaluate. Instead, VCA is implemented using recurrent neural networks (RNNs) as a model for p_{λ}(σ), whose autoregressive nature enables statistical averages over exact samples a drawn from the RNN. Since RNNs are normalized by construction, these samples allow the estimation of the entropy in Eq. (3). A detailed description of the RNN is provided in the Methods section below and the advantage of autoregressive sampling is described in Appendix C.

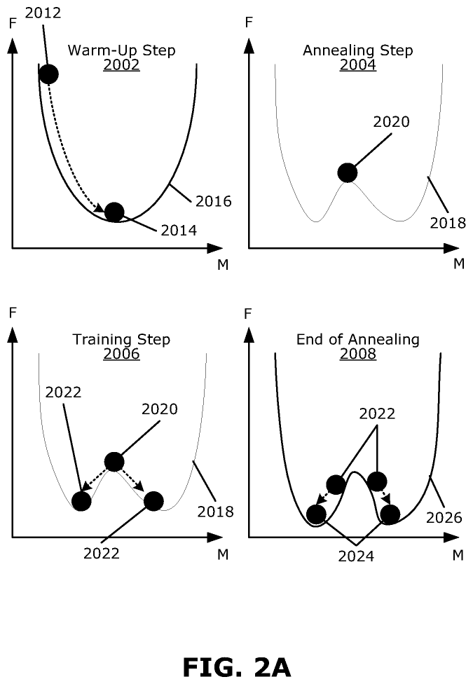

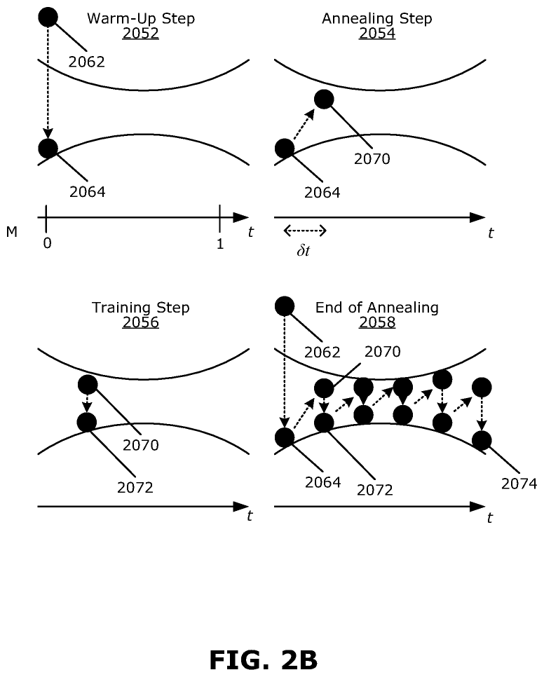

FIGS. 2A and 2B show variational neural annealing protocols. FIG. 2A shows the variational classical annealing (VCA) algorithm steps. A warm-up step 2002 brings the initialized variational state 2012 close to the minimum 2014 of the curve 2016 of free energy F at a given value of the order parameter M. This step 2002 is followed by an annealing step 2004 and a training step 2006 that bring the variational state 2020 back to the new free energy minimum 2022 of the new free energy curve 2018. Repeating the last two steps 2004, 2006 until, after the end 2008 of the annealing process, T(t=1)=0 at minimum state 2024 of the final free energy curve 2026, producing approximate solutions to H_{target} if the protocol is conducted slowly enough. This schematic illustration corresponds to annealing through a continuous phase transition with an order parameter M.

The VCA algorithm, summarized in FIG. 2A, performs a warm-up step 2002 which brings a randomly initialized distribution p_{λ} (σ) (i.e. free energy curve 2016) to an approximate equilibrium state with free energy F_{λ}(t=0) via N_{warmup} gradient descent steps (i.e. training steps 2006). At each time step t, the temperature of the system is reduced from T (t) to T (t+δt) and apply N ₜᵣₐᵢₙ gradient descent steps 2006 to re-equilibrate the model. A critical ingredient to the success of VCA is that the variational parameters optimized at temperature T (t) are reused at temperature T(t++δt) to ensure that the model's distribution is near its instantaneous equilibrium state. Repeating the last two steps (2004, 2006) N_{annealing} times, temperature T(1)=0 is reached, which is the end of the protocol. Here the distribution p_{λ}(σ) 2026 is expected to assign high probability to configurations a that solve the optimization problem. Likewise, the residual entropy Eq. (3) at T(1)=0 provides an approach to count the number of solutions to the problem Hamiltonian. Further details are provided in the Methods section below.

Simulated annealing provides a powerful heuristic for the solution of hard optimization problems by harnessing thermal fluctuations. Inspired by the latter, the advent of commercially available quantum devices has enabled the analogous concept of quantum annealing, where the solution to an optimization problem is performed by harnessing quantum fluctuations. In quantum annealing, the search for the ground state of Eq. (1) is performed by supplementing the target Hamiltonian with a quantum mechanical (or “driving”) term,

Ĥ(t)=Ĥ_{target}+f(t)Ĥ_{D}, (4)

where H_{target} in Eq. (1) is promoted to a quantum Hamiltonian Ĥ_{target} Quantum annealing algorithms typically start with a dominant driving term Ĥ_{D}>>Ĥ_{target} chosen so that the ground state of Ĥ(0) is easy to prepare. When the strength of the driving term is subsequently reduced (typically adiabatically) using a schedule function f (t), the system is annealed to the ground state of Ĥ_{target}. In analogy to its thermal counterpart, SQA emulates this process on classical computers using quantum Monte Carlo methods.

Here, the variational principle of quantum mechanics is leveraged, and a strategy is devised that emulates quantum annealing variationally. The second algorithm is referred to herein as “variational quantum annealing” (VQA). The latter is based on the variational Monte Carlo (VMC) algorithm, whose goal is to simulate the equilibrium properties of quantum systems at zero temperature (see the Methods section below). In VMC, the ground state of a Hamiltonian Ĥ is modeled through an ansatz |Ψ_{λ} [symbol] endowed with parameters λ. The variational principle guarantees that the energy [symbol] Ψ_{λ}|Ĥ|Ψ_{λ} [symbol] is an upper bound to the ground state energy of Ĥ, which is used to define a time-dependent objective function E(λ, t) ≡ [symbol] Ĥ(t) [symbol] _{λ}= [symbol] Ψ_{λ}|Ĥ(t)|Ψ_{λ} [symbol] to optimize the parameters λ.

FIG. 2B shows variational quantum annealing (VQA). VQA includes a warm-up step 2052 wherein the initial variational energy 2062 falls to an initial minimum 2064 at a first time step. This is followed by an annealing step 2054 and a training step 2056, which bring the variational energy from the initial minimum 2064 up to a higher level 2070 before dropping again to new minimum 2072 closer to the new ground state energy at a second time step. The previous two steps 2054, 2056 are repeated until reaching the target ground state of Ĥ_{target} 2074 at the end 2058 of the annealing process if annealing is performed slowly enough.

The VQA setup, summarized in FIG. 2B, applies N_{warmup} gradient descent steps (i.e. training steps 2056) to minimize ∈ (λ, t=0), which brings |Ψ_{λ} [symbol] close to the ground state of Ĥ(0). Setting t=δt while keeping the parameters λ₀ fixed results in a variational energy E(λ₀, t=δt). A set of Nₜᵣₐᵢₙ gradient descent steps 2056 bring the ansatz closer to the new instantaneous ground state, which results in a variational energy E(λ₁, t=δt). The variational parameters optimized at time step t are reused at time t+δt, which promotes the adiabaticity of the protocol (see Appendix A).

The annealing step 2054 and training step 2056 are repeated N_{annealing} times on a linear schedule (f(t)=1−t with t ∈ [0,1]) until t=1, at which point the system is expected to solve the optimization problem (i.e., arrive at final state 2074 in FIG. 2B). Note that in the simulations conducted by the researchers, no training steps are taken at t=1. Finally, normalized RNN wave functions are chosen to model |Ψ_{λ} [symbol] .

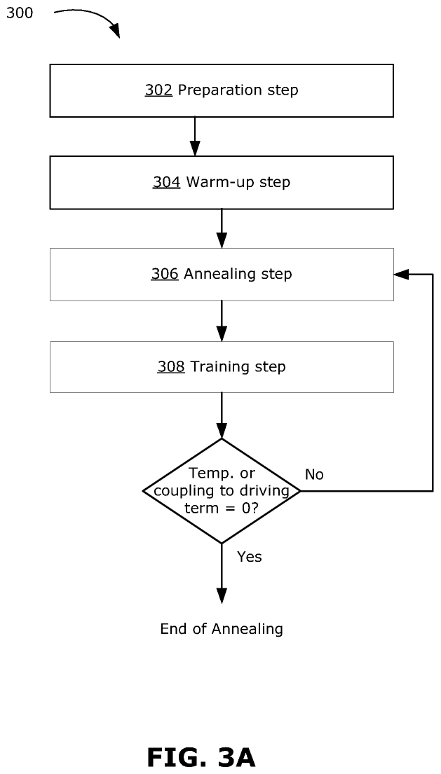

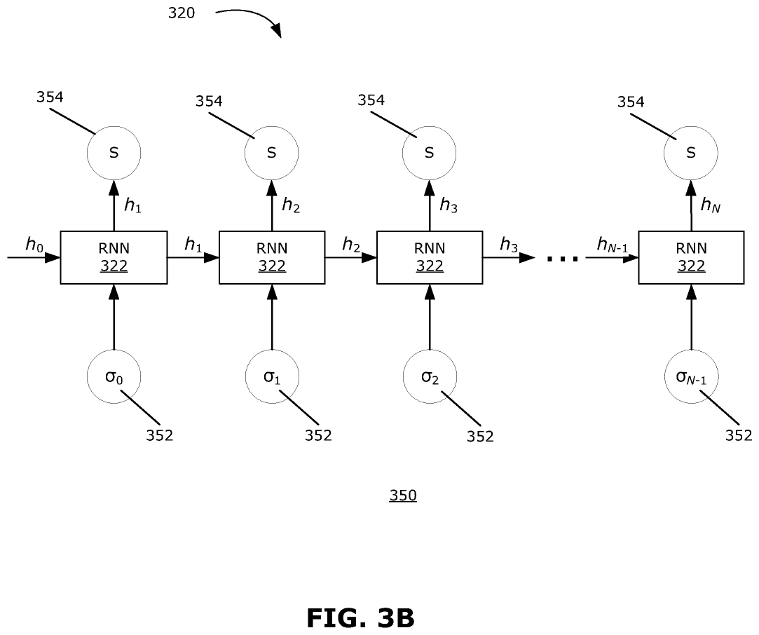

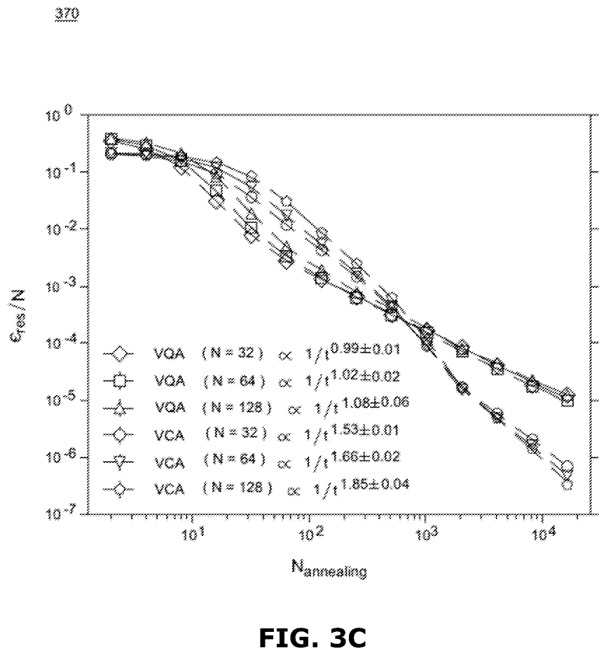

FIG. 3A shows a flowchart describing the example VCA and VQA implementations described herein, showing the steps of an example method 300 implementing the VCA and VQA protocols. At 302, a preparation step is performed. An instance of the problem Hamiltonian is prepared, the model parameters are initialized, and the temperature (for VCA) or coupling to the driving Hamiltonian (for VQA) are initialized. At 304, the warm-up step 2002 or 2052 is performed, including a user-defined number of gradient descent steps. At 306, the annealing step 2004 or 2054 is performed. Temperature (VCA), or the driving coupling (VQA), is decreased, while keeping the parameters of the model fixed. At 308, the training step 2006 or 2056 is performed, including a user-defined number of gradient descent steps while keeping temperature (VCA) or driving coupling (VQA) fixed. If temperature (VCA) or coupling to driving term (VQA) is non-zero, then the method 300 returns to repeat step 306. Otherwise, the annealing process reaches its end 2008 or 2058.

To gain theoretical insight on the principles behind VQA, a variational version of the adiabatic theorem is derived. Starting from assumptions such as the convexity of the model's optimization landscape in the warm-up phase and close to convergence during annealing, as well as noiseless energy gradients, a bound is provided on the total number of gradient descent steps Nₛₜₑₚₛ that guarantees adiabaticity and a success probability of solving the optimization problem P_{success}>1−∈. Here, ∈ is an upper bound on the overlap between the variational wave function and the excited states of Ĥ(t), i.e., | [symbol] Ψ_{⊥}(t)|Ψ_{λ} [symbol] _{|}²<∈. The symbol 1 indicates the orthogonality of excited states with respect to the ground state of Ĥ(t). It is shown show that Nₛₜₑₚₛ can be bounded as (Appendix B):

$$𝒪 ( \frac{poly ( N )}{{ϵmin}_{\{ {t}_{n} \}} ( g ( {t}_{n} ) )} ) \leq {N}_{s t e p s} \leq 𝒪 ( \frac{poly ( N )}{{ϵ}^{2} {min}_{\{ {t}_{n} \}} {( g ( {t}_{n} ) )}^{2}} ) . \qquad ( 5 )$$

The function g (t) is the energy gap between the first excited state and the ground state of Ĥ(t), N is the system size, and the set of times {tₙ} is defined in Appendix B. For hard optimization problems, the minimum gap typically decreases exponentially with N, which dominates the computational complexity of a VQA simulation, but in cases where the minimum gap scales as the inverse of a polynomial in N, then Nₛₜₑₚₛ is bounded by a polynomial in N.

Results

Annealing on Random Ising Chains

The power of VCA and VQA is now evaluated. First, one considers the task of solving for the ground state of the one-dimensional (1D) Ising Hamiltonian with random couplings J_{i,i+1},

H_{target}=−Σᵢ₌₁^{N-1}J_{i,i+1}σᵢσᵢ₊₁. (6)

One examines j_{i,i+1} sampled from a uniform distribution in the interval [0,1). Here, the ground state configuration is given either by all spins up or down, and the ground state energy is E_{G}=−Σᵢ₌₁^{N-1}J_{i,i+1}.

FIG. 3B shows an illustration of a 1D RNN 320: at each site n, the RNN cell 322 receives a hidden state hₙ₋₁ and the one-hot spin vector σₙ₋₁ 352, to generate a new hidden state hₙ that is fed into a Softmax layer 354.

The 1D RNN ansatz 320 is used for both VCA and VQA on the random Ising chains. Specifically, a tensorized RNN cell 322 without weight sharing (see the Methods section) is used. System sizes N=32,64,128 and Nₜᵣₐᵢₙ=5 are considered, which suffices to achieve accurate solutions. For VQA, a driving Hamiltonian Ĥ_{D}=−┌₀Σᵢ₌₁^{N}\hat{σ}ᵢ^{x} is used, where \hat{σ}ᵢ^{x,y,z} are Pauli matrices acting on site i. To quantify the performance of the algorithms, the residual energy is used:

∈ᵣₑₛ=[ [symbol] H_{target} [symbol] ₐᵥ−E_{G}]_{dis}, (7)

where E_{G} is the exact ground state energy of H_{target}. The arithmetic mean for statistical averages [symbol] . . . [symbol] ₐᵥ, over samples from the models is used. For VCA it means that [symbol] H_{target} [symbol] ₐᵥ≈ [symbol] H_{target} [symbol] _{λ}, while for VQA the target Hamiltonian is promoted to Ĥ_{target}=−Σᵢ₌₁^{N-1}J_{i,i+1}\hat{σ}ᵢ^{z}\hat{σ}ᵢ₊₁^{z} and [symbol] H_{target} [symbol] ₐᵥ≈ [symbol] Ĥ_{target} [symbol] _{λ}.

The researchers consider the typical mean for averaging over instances of H_{target}, i.e., [. . . ]_{dis}=exp( [symbol] ln( . . . ) [symbol] ₐᵥ). The average in the argument of the exponential stands for arithmetic mean over realizations of the couplings. Taking advantage of the autoregressive nature of the RNN, the researchers sample 10⁶ configurations at the end of the annealing, which allows the researchers to accurately estimate the model's arithmetic mean. The typical mean is taken over 25 instances of H_{target}. The protocol is executed from scratch for each realization of H_{target}.

FIG. 3C shows variational neural annealing on random Ising chains. Here the graph 370 shows the residual energy per site ∈ᵣₑₛ/N graphed vs. the number of annealing steps N_{annealing} for both VQA and VCA. The system sizes are N=32,64,128. Random positive couplings Jᵢᵢ₊₁ ∈ [0,1) are used (as described above). The error bars represent the one s.d. (standard deviation) statistical uncertainty calculated over different disorder realizations. Here and in the other plots in this disclosure, the error bars are smaller than the symbol size if not visible.

FIG. 3C reports the residual energies per site against N_{annealing}. As expected, Eᵣₑₛ is a decreasing function of N_{annealing′} which underlines the importance of adiabaticity and annealing. In these examples, the researchers observe that the decrease of the residual energy of VCA and VQA is consistent with a power-law decay for a large number of annealing steps. Whereas VCA's decay exponent is in the interval 1.5-1.9, the VQA exponent is about 0.9-1.1. These exponents suggest an asymptotic speed-up compared to SA and coherent quantum annealing, where the residual energies follow a logarithmic law. Contrary to the observations in Tommaso Zanca and Giuseppe E. Santoro, “Quantum annealing speedup over simulated annealing on random ising chains,” Phys. Rev. B 93, 224431 (2016), where quantum annealing was found superior to SA, VCA finds an average residual energy an order of magnitude more accurate than VQA for a large number of annealing steps.

Finally, the researchers note that the exponents provided above are not expected to be universal and are a priori sensitive to the hyperparameters of the algorithms. The researchers summarized the hyperparameters used in the work in Appendix E. Additional illustrations of the adiabaticity of VCA and VQA, as well as results for a chain with uniformly sampled from the discrete set {−1, +1}, are provided in Appendix A.

Edwards Anderson Model

The researchers now consider the two-dimensional (2D) Edwards-Anderson (EA) model, which is a prototypical spin glass arranged on a square lattice with nearest neighbor random interactions. The problem of finding ground states of the model has been studied experimentally and numerically from the annealing perspective, as well as theoretically from the computational complexity perspective. The EA model is given by

H_{target}=− [symbol] Jᵢⱼσᵢσⱼ, (8)

where [symbol] i,j [symbol] denote nearest neighbors. The couplings Jᵢⱼ are drawn from a uniform distribution in the interval [−1,1). In the absence of a longitudinal field, for which solving the EA model is NP-hard, the ground state can be found in polynomial time. To find the exact ground state of each random realization, the researchers use the spin-glass server.

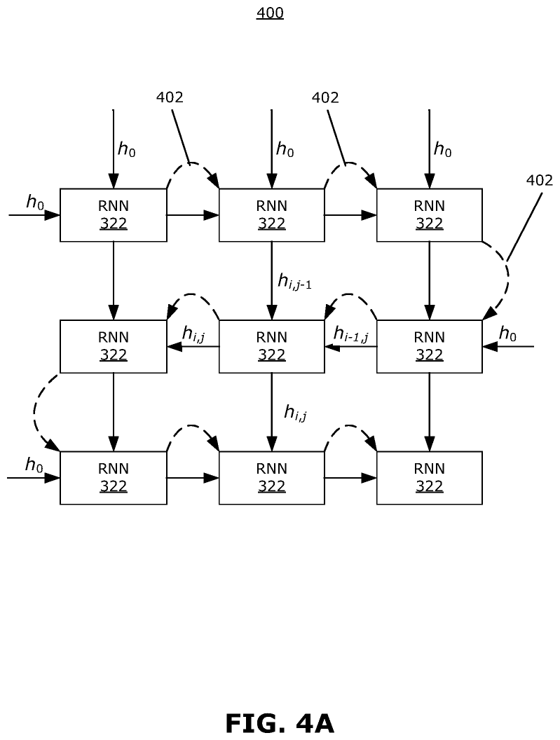

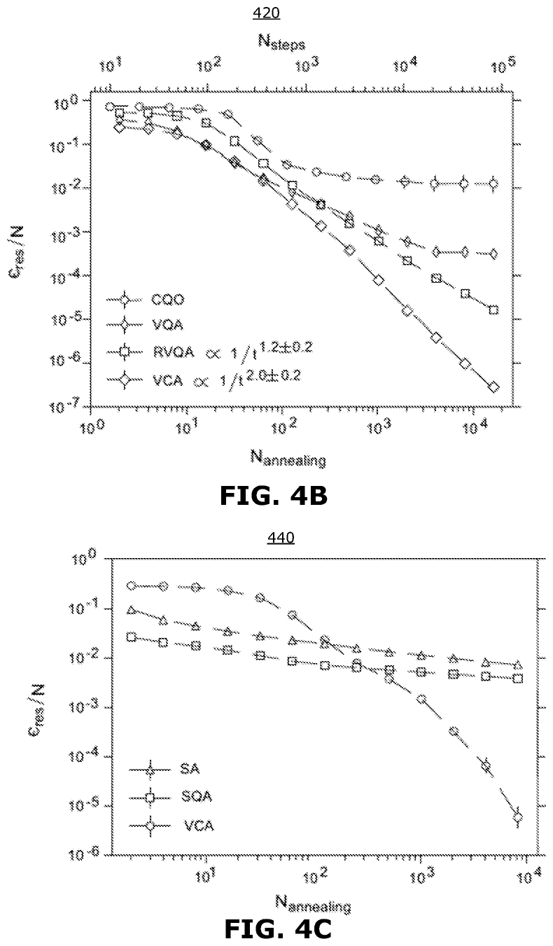

FIGS. 4A-C shows benchmarking of the two-dimensional Edwards-Anderson spin glass. FIG. 4A shows a graphical illustration of a 2D RNN 400. Each RNN cell 322 receives two hidden states h_{i,j-1} and h_{i-1,j}, as well as two input vectors σ_{i,j-1} and σ_{i-1,j} (not shown) as illustrated by the straight solid arrows. The dashed curved arrows 402 correspond to the zigzag path used for 2D autoregressive sampling. The initial memory state h₀ of the RNN and the initial inputs σ₀ (not shown) are null vectors (described in the Methods section below). An RNN that encodes the structure of the 2D geometry of the EA model is described with reference to FIG. 4A, and Tensorized RNN cells without weight sharing are used to capture the disordered nature of the system (see the Methods section). For VQA, the researchers use Ĥ_{D}=−┌₀σᵢ₌₁^{N}\hat{σ}ᵢ^{x}.

FIG. 4B is a graph 420 showing the annealing results obtained on a system with N=10×10. VCA outperforms VQA and in the adiabatic, long-time annealing regime, it produces solutions three orders of magnitude more accurate on average than VQA. In addition, the researchers investigate the performance of VQA supplemented with a fictitious Shannon information entropy term that mimics thermal relaxation effects observed in quantum annealing hardware.

This form of regularized VQA, here labelled (RVQA), is described by a pseudo free energy cost function \tilde{F}_{λ}(t)= [symbol] Ĥ(t) [symbol] _{λ}−T(t)S_{classical}(|Ψ_{λ|}²). The results in FIG. 4B do show an amelioration of the VQA performance, including changing a saturating dynamics at large N_{annealing} to a power-law like behavior. However, it appears to be insufficient to compete with the VCA scaling (see exponents in FIG. 4B). This observation suggests the superiority of a thermally driven variational emulation of annealing over a purely quantum one for this example.

To further scrutinize the relevance of the annealing effects in VCA, the researchers also consider VCA without thermal fluctuations, i.e., setting T₀=0. Because of its intimate relation to the classical-quantum optimization (CQO) methods in the existing literature, this setting is referred to herein as CQO.

FIG. 4B shows a graph 420 comparing VCA, VQA, RVQA, and CQO on a 10×10 lattice by plotting the residual energy per site vs N_{anneming}. For CQO, the researchers report the residual energy per site vs the number of optimization steps Nₛₜₑₚₛ.

FIG. 4B shows that CQO takes about 10³ training steps to reach accuracies nearing 1%. Further training (up to 10⁵ gradient descent steps) does not improve the accuracy, which indicates that CQO is prone to getting stuck in local minima. In comparison, VCA and VQA offer solutions orders of magnitude more accurate for large N annealing highlighting the importance of annealing in tackling optimization problems.

Since VCA displays the best performance, the researchers use it to demonstrate its capabilities on a 40×40 spin system and compare against SA as well as SQA. The SQA simulation uses the path-integral Monte Carlo method with P=20 trotter slices, and the researchers report averages over energies across all trotter slices, for each realization of randomness. In addition, the researchers average over the energies from 25 annealing runs on every instance of randomness for SA and SQA. To average over Hamiltonian instances, the researchers use the typical mean over 25 different realizations for the three annealing methods. The results are shown in FIG. 4C, where the researchers present the residual energies per site against N_{annealing} set so that the speed of annealing is the same for SA, SQA and VCA.

FIG. 4C shows a graph 440 comparing SA, SQA with P=20 trotter slices, and VCA using a 2D tensorized RNN ansatz on a 40×40 lattice. The annealing speed is the same for SA, SQA and VCA.

The researchers first note that the results confirm the qualitative behavior of SA and SQA in the existing literature. While SA and SQA produce lower residual energy solutions than VCA for small N annealing the researchers observe that VCA achieves residual energies about three orders of magnitude smaller than SQA and SA for a large N_{annealing} Notably, the rate at which the residual energy improves with increasing N annealing is significantly higher for VCA compared to SQA and SA even at relatively small number of annealing steps. Additional simulations on a system size of 60×60 spins (see Appendix C) corroborate this result.

Fully-Connected Spin Glasses

The researchers now focus on fully-connected spin glasses. The researchers first consider the Sherrington-Kirkpatrick (SK) model, which provides a conceptual framework for the understanding of the role of disorder and frustration in systems ranging from materials to combinatorial optimization and machine learning. The SK Hamiltonian is given by

$${H}_{target} = - \frac{1}{2} {\sum }_{i \neq j} \frac{{J}_{ij}}{\sqrt{N}} {σ}_{i} {σ}_{j} , \qquad ( 9 )$$

where {Jᵢⱼ} is a symmetric matrix whose elements Jᵢⱼ are sampled from the standard normal distribution.

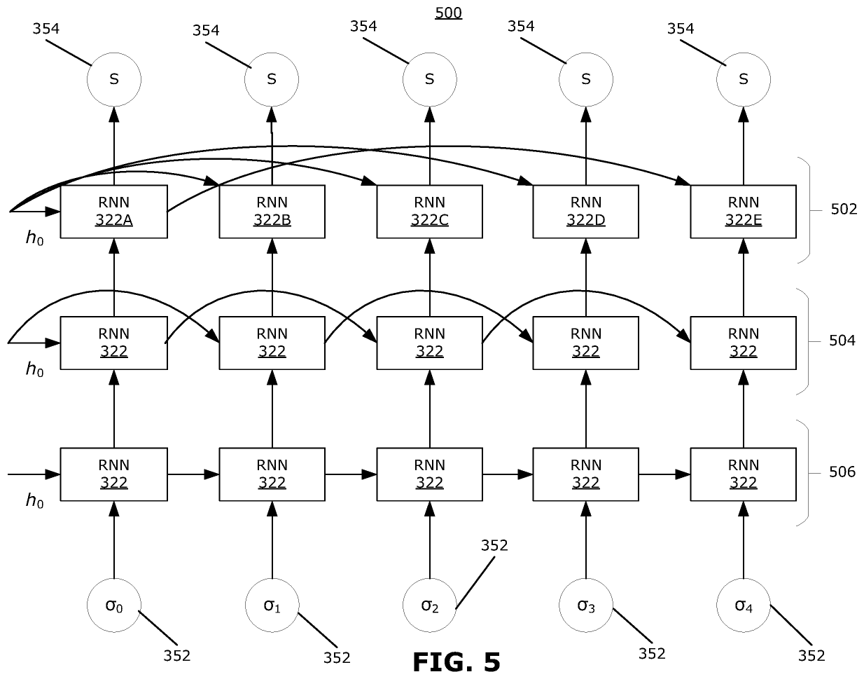

Since VCA performed best in the previous examples, the researchers use it to find ground states of the SK model for N=100 spins. Here, exact ground states energies of the SK model are calculated using the spin-glass server on a total of 25 instances of disorder. To account for long-distance dependencies between spins in the SK model, the researchers use a dilated RNN ansatz 500 of depth L=┌log₂(N)┐ (see FIG. 5) structured so that spins are connected to each other with a distance of at most [symbol] (log₂(N)) More details are provided in the Methods section below. The initial temperature is set to T₀=2. The results are compared with SQA and SA initialized with ┌₀=2 and T₀=2, respectively.

FIG. 5 shows an illustration of a dilated RNN 500 used for fully-connected spin glasses. The distance between each two RNN cells 322A-322(e) grows exponentially with depth to account for long-term dependencies. The researchers choose depth L=┌log₂(N)┐ where N is the number of spins.

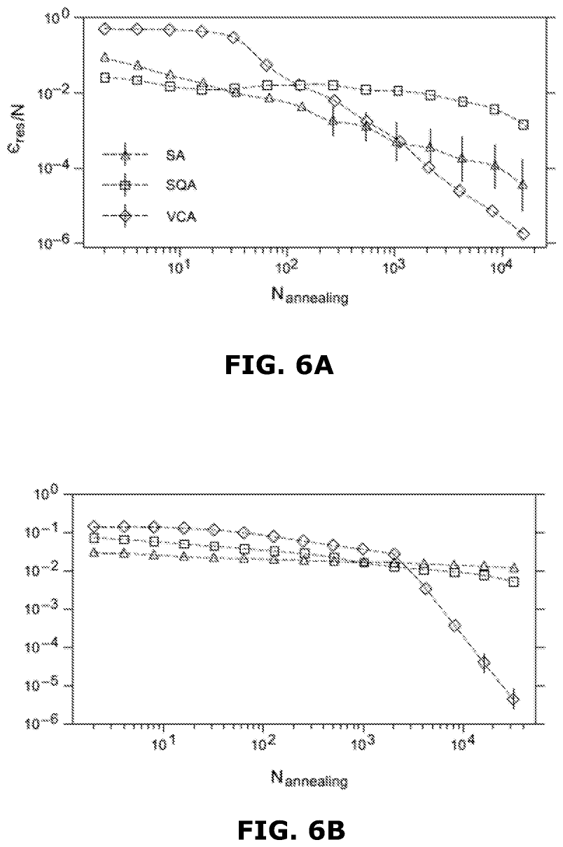

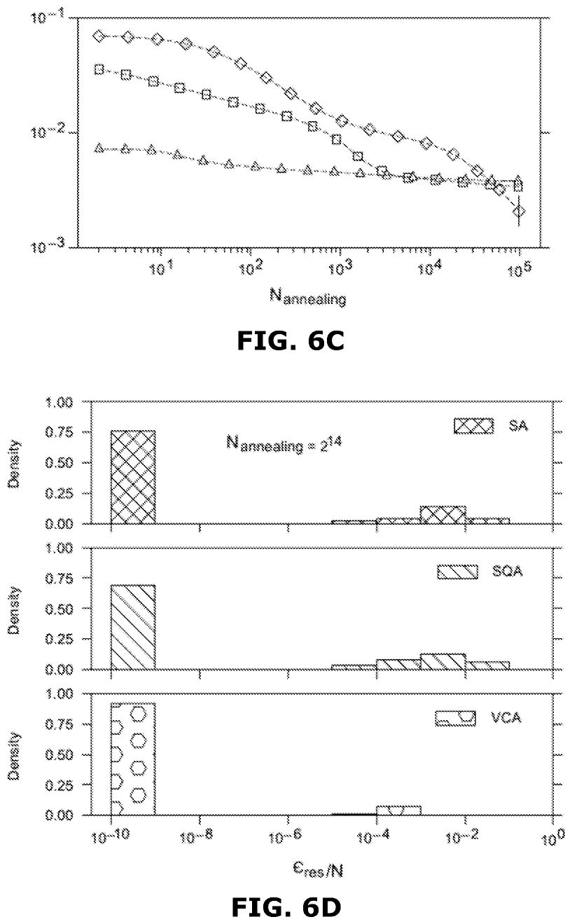

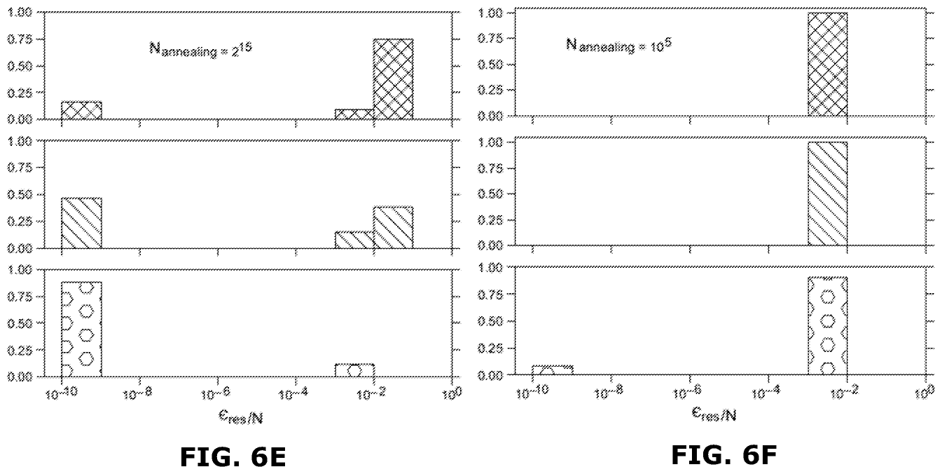

For an effective comparison, the residual energy per site is first plotted as a function of N_{annealing} for VCA, SA and SQA (P=100). Here, the SA and SQA residual energies are obtained by averaging the outcome of 50 independent annealing runs, while for VCA the researchers average the outcome of 10⁶ samples from the annealed RNN. For all methods, typical averages over 25 disorder instances are considered. The results are shown in FIG. 6A. As observed in the EA model, SA and SQA produce lower residual energy solutions than VCA for small N_{annealing}, but VCA delivers a lower ∈ᵣₑₛ when N_{annealing}<≈10³. Likewise, it can be observed that the rate at which the residual energy improves with increasing N_{annealing} is significantly higher for VCA than SQA and SA.

A closer look at the statistical behaviour of the methods at large N_{annealing} can be obtained from the residual energy histograms produced by each method, as shown in FIG. 6D. The histograms contain 1000 residual energies for each of the same 25 disorder realizations. For each instance, the researchers plot results for 1000 SA runs, 1000 samples obtained from the RNN at the end of annealing for VCA, and 10 SQA runs including contribution from each of the P=100 Trotter slices. The researchers observe that VCA is superior to SA and SQA, as it produces a higher density of low energy configurations. This indicates that, even though VCA typically takes more annealing steps, it results in a higher chance of getting accurate solutions to optimization problems than SA and SQA.

The researchers now focus on the Wishart planted ensemble (WPE), which is a class of zero-field Ising models with a first-order phase transition and tunable algorithmic hardness. These problems belong to a special class of hard problem ensembles whose solutions are known a priori, which, together with the tunability of the hardness, makes the WPE model an ideal tool to benchmark heuristic algorithms for optimization problems. The Hamiltonian of the WPE model is given by

H_{target}=−1/2Σ_{i≠j}Jᵢⱼ^{α}σᵢσⱼ. (10)

Here Jᵢⱼ^{α} is a symmetric matrix satisfying

$${J}^{α} = {\tilde{J}}^{α} - diag ( \tilde{J} )$$

$$and$$

$${\tilde{J}}^{α} = - \frac{1}{N} {W}_{α} {W}_{α}^{T} .$$

The term W_{α} is an N×[αN] random matrix satisfying W_{α}t_{ferro}=0 where t_{ferro}=(+1, +1, . . . , +1) (for details about the generation of W_{α}, see Firas Hamze, Jack Raymond, Christopher A. Pattison, Katja Biswas, and Helmut G. Katzgraber, “Wishart planted ensemble: A tunably rugged pairwise ising model with a first-order phase transition,” Physical Review E 101 (2020), 10.1103/physreve.101.052102). The ground state of the WPE model is known (i.e., it is planted) and corresponds to the states ±t_{ferro}. Interestingly, α is a tunable parameter of hardness, where for α<1 this model displays a first-order transition, such that near zero temperature the paramagnetic states are meta-stable solutions. This feature makes this model hard to solve with any annealing method, as the paramagnetic states are numerous compared to the two ferromagnetic states and hence act as a trap for a typical annealing method. The researchers benchmark the three methods (SA, SQA and VCA) for N=32 and α ∈ {0.25,0.5}.

FIGS. 6A-F show benchmarking of SA, SQA (P=100 trotter slices) and VCA on the Sherrington-Kirkpatrick (SK) model and the Wishart planted ensemble (WPE). FIGS. 6A, 6B, and 6C display the residual energy per site as a function of N_{annealing} FIG. 6A shows results for the SK model with N=100 spins. FIG. 6B shows results for the WPE with N=32 spins and a=0.5. FIG. 6C shows results for the WPE with N=32 spins and a=0.25. FIGS. 6D, 6E and 6F display the residual energy histogram for each of the different techniques and models in FIGS. 6A, 6B, and 6C, respectively. The histograms use 25000 data points for each method. Note that the researchers choose a minimum threshold of 10⁻¹⁰ for ∈ᵣₑₛ/N, which is within the numerical accuracy.

The researchers consider 25 instances of the couplings {Jᵢⱼ^{α}} and attempt to solve the model with VCA implemented using a dilated RNN ansatz with [log₂ (N)]=5 layers and T₀=1. For SQA, the researchers use an initial magnetic field ┌₀=1 and P=100, while for SA the researchers start with T₀=1.

The researchers first plot the residual energies per site (FIGS. 6B-6C). Here the researchers note that VCA is superior to SA and SQA for α=0.5 as demonstrated in FIG. 6B.

More specifically, VCA is about three orders of magnitude more accurate than SQA and SA for a large N_{annealing}. For α32 0.25 (FIG. 6C), VCA is competitive and performs comparably with SA and SQA on average for a large N_{annealing}. The researchers also represent the residual energies in a histogram form. The researchers observe that for α=0.5 in FIG. 6E, VCA achieves a higher density of configurations with ∈ᵣₑₛ/N˜10⁻⁹−10⁻¹⁰ compared to SA and SQA. For α=0.25 in FIG. 6F, VCA leads to a non-negligible density at very low residual energies as opposed to SA and SQA, whose solutions display orders of magnitude higher residual energies. Finally, the WPE simulations support the observation that VCA tends to improve the quality of solutions faster than SQA and SA for a large N_{annealing} For additional discussion about the WPE and SK results, see Appendix C. The running time estimations for SA, SQA and VCA are provided in Appendix D.

Conclusions and Outlook

In conclusion, the researchers have introduced a strategy to combat the slow sampling dynamics encountered by simulated annealing when an optimization landscape is rough or glassy. Based on annealing the variational parameters of a generalized target distribution, the scheme which the researchers dub variational neural annealing takes advantage of the power of modern autoregressive models, which can be exactly sampled without slow dynamics even when a rough landscape is encountered. The researchers implement variational neural annealing parameterized by a recurrent neural network, and compare its performance to conventional simulated annealing on prototypical spin glass Hamiltonians known to have landscapes of varying roughness. The researchers find that variational neural annealing produces accurate solutions to all of the optimization problems considered, including spin glass Hamiltonians where these techniques typically reach solutions orders of magnitude more accurate on average than conventional simulated annealing in the limit of a large number of annealing steps.

Several hyperparameters, model, hardware, and objective function choices can be used in different embodiments and may improve the methodologies described herein. Example embodiments described herein utilize a simple annealing schedule and demonstrate that reinforcement learning can be used to improve it. A critical insight gleaned from these experiments is that certain neural network architectures are more efficient on specific Hamiltonians. Thus, further improvements may be realized by exploring the intimate relation between the model architecture and the problem Hamiltonian, where it may be envisioned that symmetries and domain knowledge would guide the design of models and algorithms.

As optimization powered by deep learning becomes increasingly common, a rapid adoption of machine learning techniques may be expected in the space of combinatorial optimization, and domain-specific applications of the ideas and examples described herein may be deployed in technological and scientific areas related to physics, biology, health care, economy, transportation, manufacturing, supply chain, hardware design, computing and information technology, among others.

Methods

Recurrent Neural Network Ansätze

Recurrent neural networks model complex probability distributions p by taking advantage of the chain rule

p(σ)=p(σ₁)p(σ₂|σ₁) . . . p(σ_{N}|σN−1, . . . , σ₂, σ₁), (11)

where specifying every conditional probability p(σᵢ|σ_{<i}) provides a full characterization of the joint distribution p(σ). Here, {σₙ} are N binary variables such that αₙ=0 corresponds to a spin down while σₙ=1 corresponds to a spin up. RNNs consist of elementary cells that parameterize the conditional probabilities. In their original form, “vanilla” RNN cells compute a new “hidden state” hₙ with dimension dₕ, for each site n, following the relation

hₙ=F(W[hₙ₋₁;σₙ₋₁]b), (12)

where [hₙ₋₁; σₙ₋₁] is vector concatenation of hₙ₋₁ and a one-hot encoding aₙ₋₁ of the binary variable σₙ₋₁. The function F is a non-linear activation function. From this recursion relation, it is clear that the hidden state hₙ encodes information about the previous spins σ_{n′<n}. Hence, the hidden state hₙ provides a simple strategy to model the conditional probability p_{λ}(πₙ|σ_{<n}) as

p_{∥}(σₙ|σ_{<n})=Softmax(Uhₙ+c)·σₙ, (13)

where • denotes the dot product operation (see FIG. 3B). The set of all variational parameters of the model λ corresponds to U, W, b, c, and

$${Softmax ( v )}_{n} = \frac{exp ( {v}_{n} )}{{\sum }_{i}^{ } exp ( {v}_{i} )} . \qquad$$

The joint probability distribution p_{λ}(σ) is given by

p_{λ}(σ)=p_{λ}(σ₁)p_{λ}(σ₂|σ₁) . . . p_{λ}(σ_{N}|σ_{<N}). (14)

Since the outputs of the Softmax activation function sum to one, each conditional probability p_{λ}(σᵢ|σ_{<i}) is normalized, and hence p_{λ}(σ) is also normalized.

For disordered systems, it is natural to forgo the common practice of weight sharing of W, U, b and c in Eqs. (12), (13) and use an extended set of site-dependent variational parameters A comprised of {Wₙ}ₙ₌₁^{N} and {Uₙ}ₙ₋₁^{N} and biases {bₙ}ₙ₌^{N}, {cₙ}ₙ₌₁^{N}. The recursion relation and the Softmax layer are modified to

hₙ=F(Wₙ[hₙ₋₁; σₙ₋₁]+bₙ), (15)

and

p_{λ}(σₙ|σ_{<n})=Softmax(Uₙhₙ+cₙ)·σₙ, (16)

respectively. Note that the advantage of not using weight sharing for disordered systems is further demonstrated in Appendix F.

The researchers also consider a tensorized version of vanilla RNNs which replaces the concatenation operation in Eq. (15) with the operation

hₙ=F(σₙ₋₁^{T}Tₙhₙ₋₁+bₙ), (17)

where σ^{T} is the transpose of σ, and the variational parameters λ are {Tₙ}ₙ₌₁^{N}, {Uₙ}ₙ₋₁^{N}, {bₙ}ₙ₌₁^{N} and {cₙ}ₙ₋₁^{N}. This form of tensorized RNN increases the expressiveness of the ansatz as illustrated in Appendix F.

For two-dimensional systems, the researchers make use of a 2-dimensional extension of the recursion relation in vanilla RNNs

h_{i,j}=F(W_{i,j}^{(h)}[h_{i-1,j};σ_{i-1,j}]+W_{i,j}^{(v)}[h_{i,j-1};σ_{i,j-1}]+b_{i,j}). (18)

To enhance the expressive power of the model, the researchers promote the recursion relation to a tensorized form

h_{i,j}=F([σ_{i-1,j}; σ_{i,j-1}]T_{i,j}[h_{i-1,j}; h_{i,j-1}]+b_{i,j}). (19)

Here, T_{i,j} are site-dependent weight tensors that have dimension 4×2dₕ×dₕ. The researchers also note that the coordinates (i−1,j) and (i,j−1) are path-dependent, and are given by the zigzag path, illustrated by the black arrows in FIG. 4A. Moreover, to sample configurations from the 2D tensorized RNNs, the researchers use the same zigzag path as illustrated by the dashed arrows in FIG. 4A.

For models such as the Sherrington-Kirkpatrick model and the Wishart planted ensemble, every spin interacts with each other. To account for the long-distance nature of the correlations induced by these interactions, the researchers use dilated RNNs, which are known to alleviate the vanishing gradient problem. Dilated RNNs are multi-layered RNNs that use dilated connections between spins to model long-term dependencies, as illustrated in FIG. 5. At each layer 1≤l≤L, e.g. layers 502, 504, 506, the hidden state is computed as

hₙ^{(l)}=F(Wₙ^{(l)}[h_{max(0,n-2}_{^{l−1}}^{(l)}; hₙ^{(l-1)}]+bₙ^{(l)}).

Here hₙ⁽⁰⁾=σₙ₋₁ and the conditional probability is given by

p_{λ}(σₙ|σ_{<n})=Softmax(Uₙhₙ^{(L)}+cₙ)·σₙ.

In their work, the researchers choose the size of the hidden states hₙ^{(l)}, where l>0, as constant and equal to dₕ. The researchers also use a number of layers L=┌log₂(N)┐, where N is the number of spins and [ . . . ] is the ceiling function. This means that two spins are connected with a path whose length is bounded by [symbol] (log₂(N)), which follows the spirit of the multi-scale renormalization ansatz. For more details on the advantage of dilated RNNs over tensorized RNNs see Appendix F.

The researchers finally note that for all the RNN architectures in this work, the researchers found accurate results using the exponential linear unit (ELU) activation function, defined as:

$$E L U ( x ) = \{ \begin{matrix}x , & if x \geq 0 , \\ exp ( x ) - 1 & if x < 0.\end{matrix} \qquad$$

Minimizing the Variational Free Energy

To implement the variational classical annealing algorithm, the researchers use the variational free energy

F_{λ}(T)= [symbol] H_{target} [symbol] _{λ}−TS_{classical}(p_{λ}), (20)

where the target Hamiltonian H_{target} encodes the optimization problem and T is the temperature. Moreover, S_{classical} is the entropy of the distribution p_{λ}. To estimate F_{λ}(T) the researchers take Nₛ exact samples σ⁽ⁱ⁾˜p_{λ} (i=1, . . . , Nₛ) drawn from the RNN and evaluate

$${F}_{λ} ( T ) \approx \frac{1}{{N}_{s}} {\sum }_{i = 1}^{{N}_{s}} {F}_{l o c} ( {σ}^{( i )} ) , \qquad$$

where the local free energy is F_{loc}(σ)=H_{target}(σ)+Tlog(p_{λ}(σ)). Similarly, the gradients are given by

$${\partial }_{λ} {F}_{λ} ( T ) \approx \frac{1}{{N}_{s}} {\sum }_{i = 1}^{{N}_{s}} {\partial }_{λ} log ( {p}_{λ} ( {σ}^{( i )} ) ) \times ( {F}_{l o c} ( {σ}^{( i )} ) - {F}_{λ} ( T ) ) ,$$

where the researchers subtract F_{λ}(T) in order to reduce noise in the gradients. The researchers note that this variational scheme exhibits a zero-variance principle, namely that the local free energy variance per spin

$${σ}_{F}^{2} ≡ \frac{var ( \{ {F}_{loc} ( σ ) \} )}{N} , \qquad ( 21 )$$

becomes zero when p_{λ} matches the Boltzmann distribution, provided that mode collapse is avoided.

The gradient updates are implemented using the Adam optimizer. Furthermore, the computational complexity of VCA for one gradient descent step is [symbol] (Nₛ×N×dₙ²) for 1D RNNs and 2D RNNs (both vanilla and tensorized versions) and [symbol] (Nₛ×N_{log}(N)×dₕ²) for dilated RNNs. Consequently, VCA has lower computational cost than VQA, which is implemented using VMC (see the Methods section).

Finally, the researchers note that in these implementations no training steps are performed at the end of annealing for both VCA and VQA.

Variational Monte Carlo

The main goal of Variational Monte Carlo (VMC) is to approximate the ground state of a Hamiltonian Ĥ through the iterative optimization of an ansatz wave function |Ψ_{λ} [symbol] . The VMC objective function is given by

$$E ≡ \frac{〈 {Ψ}_{λ} \vert \hat{H} \vert {Ψ}_{λ} 〉}{〈 {Ψ}_{λ} \vert {Ψ}_{λ} 〉} .$$

The researchers note that an important class of stoquastic many-body Hamiltonians has ground states |Ψ [symbol] with strictly real and positive amplitudes in the standard product spin basis. These ground states can be written down in terms of probability distributions,

$$\vert Ψ 〉 = {\sum }_{σ} Ψ ( σ ) \vert σ 〉 = {\sum }_{σ} \sqrt{P ( σ )} \vert σ 〉 .$$

To approximate this family of states, the researchers use an RNN wave function, namely Ψ_{λ}(σ)=\sqrt{p_{λ}(σ)}. Extensions to complex-valued RNN wave functions are defined in the existing literature, and results on their ability to simulate variational quantum annealing of non-stoquastic Hamiltonians have been reported elsewhere. These families of RNN states are normalized by construction (i.e., [symbol] Ψ_{λ}|Ψ_{λ} [symbol] ₌1) and allow for accurate estimates of the energy expectation value. By taking Nₛ exact samples σ⁽ⁱ⁾˜p_{λ}(i=1, . . . , Nₛ), it follows that

$$E \approx \frac{1}{{N}_{s}} {\sum }_{i = 1}^{{N}_{s}} {E}_{loc} ( {σ}^{( i )} ) . \qquad$$

The local energy is given by

$${E}_{loc} ( σ ) = {\sum }_{{σ}^{′}} {H}_{{σσ}^{′}} \frac{{Ψ}_{λ} ( {σ}^{′} )}{{Ψ}_{λ} ( σ )} , \qquad ( 23 )$$

where the sum over σ′ is tractable when the Hamiltonian Ĥ is local. Similarly, the researchers can also estimate the energy gradients as

$${\partial }_{λ} E = \frac{2}{{N}_{s}} {\sum }_{i = 1}^{{N}_{s}} {\partial }_{λ} log ( {Ψ}_{λ} ( {σ}^{( i )} ) ) ( {E}_{loc} ( {σ}^{( i )} ) - E ) . \qquad$$

Here, the researchers can subtract the term E in order to reduce noise in the stochastic estimation of the gradients without introducing a bias. In fact, when the ansatz is close to an eigenstate of Ĥ, then E_{loc}, (σ)≈E, which means that the variance of gradients Var (∂_{λ}_{ⱼ}E)≈0 for each variational parameter λⱼ. The researchers note that this is similar in spirit to the control variate methods in Monte Carlo and to the baseline methods in reinforcement learning.

Similarly to the minimization scheme of the variational free energy in the Methods section, VMC also exhibits a zero-variance principle, where the energy variance per spin

$${σ}^{2} ≡ \frac{var ( \{ {E}_{loc} ( σ ) \} )}{N} , \qquad ( 24 )$$

becomes zero when |Ψ_{λ} [symbol] matches an excited state of Ĥ, which thanks to the minimization of the variational energy E is likely to be the ground state |Ψ_{G} [symbol] .

The gradients ∂_{λ}log (Ψ_{λ}(σ)) are numerically computed using automatic differentiation. The researchers use the Adam optimizer to perform gradient descent updates, with a learning rate η, to optimize the variational parameters λ of the RNN wave function. The researchers note that in the presence of [symbol] (N) non-diagonal elements in a Hamiltonian Ĥ, the local energies E_{loc}(σ) have [symbol] (N) terms (see Eq. (23)). Thus, the computational complexity of one gradient descent step is [symbol] (Nₛ×N²×dₕ²) for 1D RNNs and 2D RNNs (both vanilla and tensorized versions).

Simulated Quantum Annealing and Simulated Annealing

Simulated Quantum Annealing is a standard quantum-inspired classical technique that has traditionally been used to benchmark the behavior of quantum annealers. It is usually implemented via the path-integral Monte Carlo method, a Quantum Monte Calo (QMC) method that simulates equilibrium properties of quantum systems at finite temperature. To illustrate this method, consider a D-dimensional time-dependent quantum Hamiltonian

$$\hat{H} ( t ) = - {\sum }_{i , j} {J}_{i j} {\hat{σ}}_{i}^{z} {\hat{σ}}_{j}^{z} - Γ ( t ) {\sum }_{i = 1}^{N} {\hat{σ}}_{i}^{x} ,$$

where ┌(t)=┌₀(1−t) controls the strength of the quantum annealing dynamics at a time t ∈ [0,1]. By applying the Suzuki-Trotter formula to the partition function of the quantum system,

Z=Trexp{−βĤ(t))}, (25)

with the inverse temperature

$$β = \frac{1}{T} ,$$

the researchers can map the D-dimensional quantum

Hamiltonian onto a (D+1) classical system consisting of P coupled replicas (Trotter slices) of the original system:

$${H}_{D + 1} ( t ) = - {\sum }_{k = 1}^{P} ( {\sum }_{i , j} {J}_{ij} {σ}_{i}^{k} {σ}_{j}^{k} + {J}_{⊥} ( t ) {\sum }_{i = 1}^{N} {σ}_{i}^{k} {σ}_{i}^{k + 1} ) ,$$

where σᵢ^{k} is the classical spin at site i and replica k. The term J_{⊥}(t) corresponds to uniform coupling between σᵢ^{k} and σᵢ^{k+1} for each site i, such that

$${J}_{⊥} ( t ) = - \frac{PT}{2} ln ( tanh ( \frac{Γ ( t )}{PT} ) ) .$$

The researchers note that periodic boundary conditions σ^{P+1}≡σ¹ arise because of the trace in Eq. (25).

Interestingly, the researchers can approximate Z with an effective partition function Zₚ at temperature PT given by:

$${Z}_{p} ∝ Trexp \{ - \frac{{H}_{D + 1} ( t )}{PT} \} ,$$

which can now be simulated with a standard Metropolis-Hastings Monte Carlo algorithm. A key element to this algorithm is the energy difference induced by a single spin flip at site σᵢ^{k}, which is equal to

$${Δ}_{i} {E}_{local} = 2 {\sum }_{j} {J}_{ij} {σ}_{i}^{k} {σ}_{j}^{k} + 2 {J}_{⊥} ( t ) ( {σ}_{i}^{k - 1} {σ}_{i}^{k} + {σ}_{i}^{k} {σ}_{i}^{k + 1} ) .$$

Here, the second term encodes the quantum dynamics. In these simulations the researchers consider single spin flip (local) moves applied to all sites in all slices. The researchers can also perform a global move, which means flipping a spin at location i in every slice k. Clearly this has no impact on the term dependent on J_{⊥}, because it contains only terms quadratic in the flipped spin, so that

$${Δ}_{i} {E}_{global} = 2 {\sum }_{k = 1}^{P} {\sum }_{j} {J}_{ij} {σ}_{i}^{k} {σ}_{j}^{k} .$$

In summary, a single Monte Carlo step (MCS) consists of first performing a single local move on all sites in each k-th slice and on all slices, followed by a global move for all sites. For the SK model and the WPE model studied in this paper, the researchers use P=100, whereas for the EA model the researchers use P=20 similarly to existing approaches in the literature. Before starting the quantum annealing schedule, the researchers first thermalize the system by performing SA from a temperature T₀=3 to a final temperature 1/P (so that PT=1). This is done in 60 steps, where at each temperature the researchers perform 100 Metropolis moves on each site.

The researchers then perform SQA using a linear schedule that decreases the field from ┌₀ to a final value close to zero ┌(t=1)=10⁻⁸, where five local and global moves are performed for each value of the magnetic field ┌(t), so that it is consistent with the choice of Nₜᵣₐᵢₙ=5 for VCA (see above). Thus, the number of MCS is equal to five times the number of annealing steps.

For the standalone SA, the researchers decrease the temperature from T₀ to T(t=1)=10⁻⁸. Here, a single MCS consists of a Monte Carlo sweep, i.e., attempting a spin-flip for all sites. For each thermal annealing step, the researchers perform five MCS, and hence similar to SQA, the number of MCS is equal to five times the number of annealing steps. Furthermore, the researchers do a warm-up step for SA, by performing N_{warmup} MCS to equilibrate the Markov Chain at the initial temperature T₀ and to provide a consistent choice with VCA (see above).

Appendix A: Numerical Proof of Principle of Adiabaticity

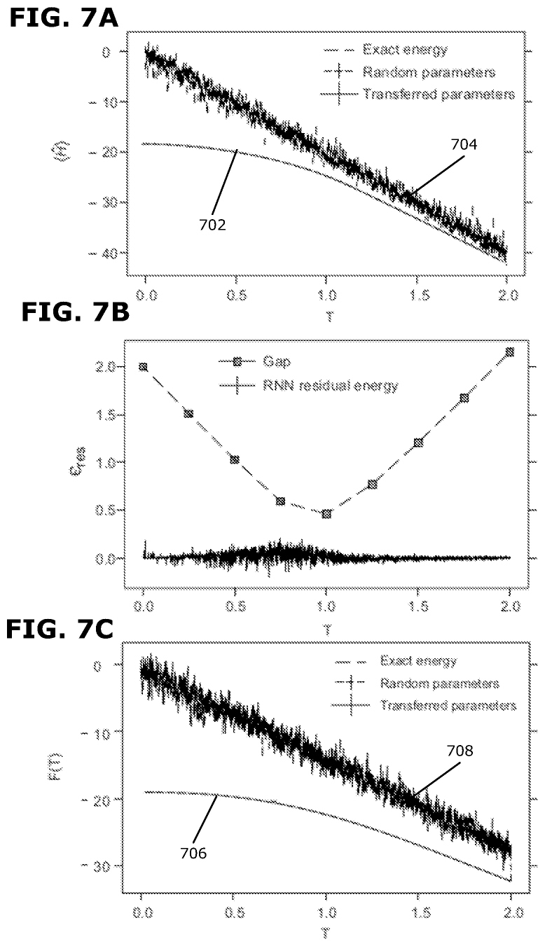

As demonstrated in the Results section, both VQA and VCA are effective at finding the classical ground state of disordered spin chains. This Appendix A further describes the adiabaticity of both VQA and VCA. First, VQA is performed on the uniform ferromagnetic Ising chain (i.e., J_{i,i+1}=1) with N=20 spins and open boundary conditions with an initial transverse field ┐₀=2. Here, a tensorized RNN wave function is used with weight sharing across sites of the chain. The value chosen for N_{annealing}=1024. FIG. 7A shows that the variational energy tracks the exact ground energy throughout the annealing process with high accuracy. The researchers also observe that optimizing an RNN wave function from scratch, i.e., randomly reinitializing the parameters of the model at each new value of the transverse magnetic field is not optimal. This observation underlines the importance of transferring the parameters of the wave function ansatz after each annealing step. Furthermore, FIG. 7B illustrates that the RNN wave function's residual energy is much lower compared to the gap throughout the annealing process, which shows that VQA remains adiabatic for a large number of annealing steps.

FIGS. 7A-C show numerical evidence of adiabaticity on the uniform Ising chain with N=20 spins for VQA in FIGS. 7A and 7B and VCA in FIG. 7C. FIG. 7A graphs variational energy of RNN wave function against the transverse magnetic field F, with A initialized using the parameters optimized in the previous annealing step (transferred parameters, shown by curve 702) and with random parameter reinitialization (random parameters, shown by curve 704). These strategies are compared with the exact energy obtained from exact diagonalization (dashed black line). FIG. 7B graphs residual energy of the RNN wave function against the transverse field F. Throughout annealing with VQA, the residual energy is always much smaller than the gap within error bars. FIG. 7C graphs variational free energy against temperature T for a VCA run with A initialized using the parameters optimized in the previous annealing step (transferred parameters, shown by curve 706) and with random reinitialization (random parameters, shown by curve 708).

Similarly, in FIG. 7C the researchers perform VCA with an initial temperature T₀=2 on the same model, the same system size, the same ansatz, and the same number of annealing steps. The researchers see an excellent agreement between the RNN wave function free energy and the exact free energy, highlighting once again the adiabaticity of the emulation of classical annealing, as well as the importance of transferring the parameters of the ansatz after each annealing step. Taken all together, the results in FIG. 7 support the notion that VQA and VCA evolutions can be adiabatic.

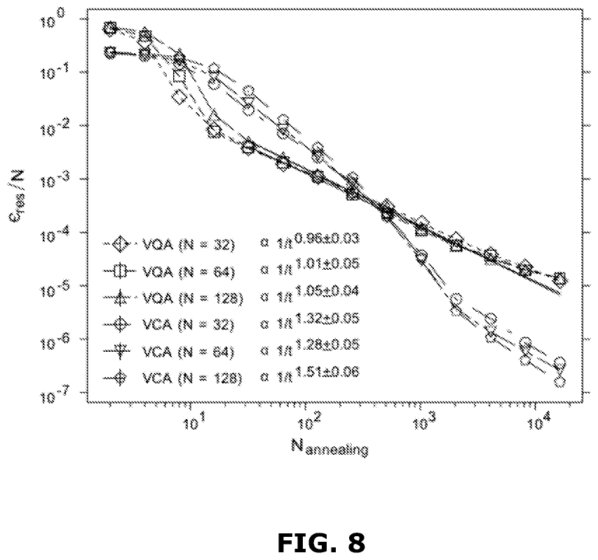

FIG. 8 illustrates the residual energies per site against the number of annealing steps N_{annealing}. Here, the researchers consider uniformly sampled from the discrete set {−1, +1}, where the ground state configuration is disordered and the ground state energy is given by E_{G}=−Σᵢ₌₁^{N-1}|J_{i,i+1}|=−(N−1). The decay exponents for VCA are in the interval 1.3-1.6 and the VQA exponent are approximately 1. These exponents also suggest an asymptotic speed-up compared to SA and coherent quantum annealing, where the residual energies follow a logarithmic law. The latter confirms the robustness of the observations in FIG. 3.

FIG. 8 shows variational annealing on random Ising chains, where the researchers represent the residual energy per site ∈ᵣₑₛ/N vs N_{annealing} for both VQA and VCA. The system sizes are N=32,64,128 and the researchers use random discrete couplings J_{i,j+1}∈{−1,1}.

Appendix B: The Variational Adiabatic Theorem

In this section, the researchers derive a sufficient condition for the number of gradient descent steps needed to maintain the variational ansatz close to the instantaneous ground state throughout the VQA simulation. First, consider a variational wave function |Ψ_{λ}> and the following time-dependent Hamiltonian:

Ĥ(t)=Ĥ_{target}+f(t)Ĥ_{D},

The goal is to find the ground state of the target Hamiltonian Ĥ_{target} by introducing quantum fluctuations through a driving Hamiltonian Ĥ_{D}, where Ĥ_{D}>>Ĥ_{target}. Here f (t) is a decreasing schedule function such that f (0)=1, f (1)=0 and t ∈ [0,1].

Let E (λ, t)= [symbol] Ψ_{λ}|Ĥ(t)|Ψ_{λ} [symbol] , and E_{G}(t), E_{E}(t) the instantaneous ground/excited state energy of the Hamiltonian Ĥ(t), respectively. The instantaneous energy gap is defined as g(t)≡E_{E}(t)−E_{G}(t).

To simplify discussion, the researchers consider the case of a target Hamiltonian that has a non-degenerate ground state. Here, the researchers decompose the variational wave function as:

|Ψ_{λ}>=(1−a(t))^{1/2}|Ψ_{G}(t)>+a(t)^{1/2}|Ψ_{⊥}(t)>,

where |Ψ_{G}(t)> is the instantaneous ground state and |Ψ_{⊥}(t)> is a superposition of all the instantaneous excited states. From this decomposition, one can show that:

$$a ( t ) \leq \frac{E ( λ , t ) - {E}_{G} ( t )}{g ( t )} . \qquad ( 26 )$$

As a consequence, in order to satisfy adiabaticity, i.e., | [symbol] Ψ_{⊥}(t)|Ψ_{λ}>|²<<1 for all times t, then one should have a(t)<∈ <<1 where ∈ is a small upper bound on the overlap between the variational wave function and the excited states. This means that the success probability P_{success} of obtaining the ground state at t=1 is bounded from below by 1−∈. From Eq. (26), to satisfy a(t)<∈, it is sufficient to have:

∈ᵣₑₛ(λ,t)≡E(λ, t)−E_{G}(t)<∈ g(t). (27)

To satisfy the latter condition, the researchers require a slightly stronger condition as follows:

$${ϵ}_{res} ( λ , t ) < \frac{ϵ g ( t )}{2} . \qquad ( 28 )$$

In the researchers' derivation of a sufficient condition on the number of gradient descent steps to satisfy the previous requirement, the researchers use the following set of assumptions:
(A1) |∂ₜ^{k}E_{G}(t)|,|∂ₜ^{k}g(t)|,|∂ₜ^{k}f(t)|≤ [symbol] (poly(N), for all 0≤t≤1 and for k ∈{1,2}.
(A2) | [symbol] Ψ_{λ}|Ĥ_{D}|Ψ_{λ} [symbol] |≤ [symbol] (poly(N)) for all possible parameters λ of the variational wave function.
(A3) No anti-crossing during annealing, i.e., g(t)≠0, for all 0≤t≤1.
(A4) The gradients ∂_{λ}E(λ, t) can be calculated exactly, are L(t)-Lipschitz with respect to λ and L(t)≤ [symbol] (poly(N)) for all 0≤t≤1.
(A5) Local convexity, i.e., close to convergence when ∈ᵣₑₛ(λ,t)<∈ g(t), the energy landscape of E(λ, t) is convex with respect λ, for all 0<t≤1.

Note that this assumption is ∈-dependent.
(A6) The parameters vector λ is bounded by a polynomial in N. i.e., ∥A∥≤ [symbol] (poly(N)), where the researchers define “∥.∥” as the euclidean L₂ norm.
(A7) The variational wave function |Ψ_{λ} [symbol] is expressive enough, i.e.,

$${min}_{λ} {ϵ}_{res} ( λ , t ) < \frac{ϵ g ( t )}{4} , ∀ t ∈ [ 0 , 1 ] .$$

Note that this assumption is also c-dependent.
(A8) At t=0, the energy landscape of E(λ, t=0) is globally convex with respect to λ.

Theorem Given the assumptions (A1) to (A8), a sufficient (but not necessary) number of gradient descent steps Nₛₜₑₚₛ to satisfy the condition in Eq. (28) during the VQA protocol, is bounded as:

$$𝒪 ( \frac{poly ( N )}{ϵ {min}_{\{ {t}_{n} \}} ( g ( {t}_{n} ) )} ) \leq {N}_{steps} \leq 𝒪 ( \frac{poly ( N )}{{ϵ}^{2} {min}_{\{ {t}_{n} \}} {( g ( {t}_{n} ) )}^{2}} ) ,$$

where (t₁, t₂, t₃, . . . ) is an increasing finite sequence of time steps, satisfying t₁=0 and tₙ₊₁=tₙ+δtₙ, where

$$δ {t}_{n} = 𝒪 ( \frac{ϵ g ( {t}_{n} )}{poly ( N )} ) .$$

Proof: In order to satisfy the condition Eq. (28) during the VQA protocol, the researchers follow these steps:
Step 1 (warm-up step): the researchers prepare the variational wave function at the ground state at t=0 such that Eq. (28) is verified at time t=0.
Step 2 (annealing step): the researchers change time t by an infinitesimal amount ot, so that the condition (27) is verified at time t+δt.
Step 3 (training step): the researchers tune the parameters of the variational wave function, using gradient descent, so that the condition (28) is satisfied at time t+δt.
Step 4: the researchers loop over steps 2 and 3 until the researchers arrive at t=1, where the researchers expect to obtain the ground state energy of the target Hamiltonian.

Let the researchers first start with step 2 assuming that step 1 is verified. In order to satisfy the requirement of this step at time t, then ot has to be chosen small enough so that

∈ᵣₑₛ(λₜ, t+δt)<∈g(t+δt) (29)

is verified given that the condition (28) is satisfied at time t. Here, λₜ are the parameters of the variational wave function that satisfies the condition (28) at time t. To get a sense of how small δt should be, the researchers do a Taylor expansion, while fixing the parameters λₜ, to get:

$${ϵ}_{res} ( {λ}_{t} , t + δ t ) = {ϵ}_{res} ( {λ}_{t} , t ) + {\partial }_{t} {ϵ}_{res} ( {λ}_{t} , t ) δ t + 𝒪 ( {( δ t )}^{2} ) , < \frac{ϵ g ( t )}{2} + {\partial }_{t} {ϵ}_{res} ( {λ}_{t} , t ) δ t + 𝒪 ( {( δ t )}^{2} ) ,$$

where the researchers used the condition (28) to go from the second line to the third line. Here, ∂ₜ∈ᵣₑₛ(λₜ,t)=∂ₜf (t) [symbol] Ĥ_{D} [symbol] −∂ₜE_{G}(t). To satisfy the condition (27) at time t+δt, it is enough to have the right hand side of the previous inequality to be much smaller than the gap at t+δt, i.e.,

$$\frac{ϵ g ( t )}{2} + {\partial }_{t} {ϵ}_{res} ( {λ}_{t} , t ) δ t + 𝒪 ( {( δ t )}^{2} ) < ϵ g ( t + δ t ) .$$

By Taylor expanding the gap, the researchers get:

$${\partial }_{t} {ϵ}_{res} ( {λ}_{t} , t ) δ t + 𝒪 ( {( δ t )}^{2} ) < \frac{ϵ g ( t )}{2} + ϵ {\partial }_{t} g ( t ) δ t + 𝒪 ( {( δ t )}^{2} ) ,$$

hence, it is enough to satisfy the following condition:

$$( {\partial }_{t} {ϵ}_{res} ( {λ}_{t} , t ) - ϵ {\partial }_{t} g ( t ) ) δ t + 𝒪 ( {( δ t )}^{2} ) < \frac{ϵ g ( t )}{2} . \qquad ( 30 )$$

Using the Taylor-Laplace formula, one can express the Taylor remainder term [symbol] ((δt)²) as follows:

[symbol]

((δt)δt)²)=∫ₜ^{t+δt}(τ−t)A(τ)dτ,

where A(τ)=∂_{τ}²∈ᵣₑₛ(λₜ, τ)−∈ ∂_{τ}²g(τ)=∂_{τ}²f(τ) [symbol] Ĥ_{D} [symbol] −∂_{τ}²E_{G}(τ)−∈ ∂_{τ}²g(τ) and τ is between t and t+δt. The last expression can be bounded as follows:

$$𝒪 ( {( δ t )}^{2} ) \leq {\int }_{t}^{t + δ t} ( τ - t ) \vert A ( τ ) \vert d τ \leq \frac{{( δ t )}^{2}}{2} sup ( \vert A \vert ) .$$

where “sup (|A|)” is the supremum of |A| over the interval [0,1]. Given assumptions (A1) and (A2), then sup(|A|) is bounded from above by a polynomial in N, hence:

[symbol]

((δt)²)≤ [symbol] (poly(N))(δt)²≤ [symbol] (poly(N))δt,

where the last inequality holds since δt≤1 as t ∈ [0,1], while the researchers note that it is not necessarily tight. Furthermore, since (∂ₜ∈ᵣₑₛ(λₜ, t)−∈∂ₜg(t)) is also bounded from above by a polynomial in N (according to assumptions (A1) and (A2)), then in order to satisfy Eq. (30), it is sufficient to require the following condition:

$$𝒪 ( poly ( N ) ) δ t < \frac{ϵ g ( t )}{2} .$$

Thus, it is sufficient to take:

$$δ t = 𝒪 ( \frac{ϵ g ( t )}{poly ( N )} ) . \qquad ( 31 )$$

By taking account of assumption (A3), ot can be taken non-zero for all time steps t. As a consequence, assuming the condition (31) is verified for a non-zero ot and a suitable [symbol] (1) prefactor, then the condition (29) is also verified.

The researchers can now move to step 3. Here, the researchers apply a number of gradient descent steps Nₜᵣₐᵢₙ(t) to find a new set of parameters λ_{t+δt} such that:

$${ϵ}_{res} ( {λ}_{t + δ t} , t + δ t ) = E ( {λ}_{t + δ t} , t + δ t ) - {E}_{G} ( t + δ t ) < \frac{ϵ g ( t + δ t )}{2} , \qquad ( 32 )$$

To estimate the scaling of the number of gradient descent steps Nₜᵣₐᵢₙ(t) needed to satisfy (32), the researchers make use of assumptions (A4) and (A5). The assumption (A5) is reasonable providing that the variational energy E (λₜ, t+δt) is very close to the ground state energy E_{G}(t+δt), as given by Eq. (29). Using the above assumptions and assuming that the learning rate η(t)=1/L(t), the researchers can use a well-known result in convex optimization (as described in (Nesterov Y. (2018) Smooth Convex Optimization. In: Lectures on Convex

Optimization. Springer Optimization and Its Applications, vol 137. Springer, Cham. https://doi.org/10.1007/978-3-319-91578-4_2), which states the following inequality:

$$E ( {\tilde{λ}}_{t} , t + δ t ) - {min}_{λ} E ( λ , t + δ t ) \leq \frac{2 L ( t ) {‖ {λ}_{t} - {λ}_{t + δ t}^{*} ‖}^{2}}{{N}_{train} ( t ) + 4} .$$

Here, \tilde{λ}ₜ are the new variational parameters obtained after applying Nₜᵣₐᵢₙ(t+δt) gradient descent steps starting from λₜ. Furthermore, λ_{t+δt}* are the optimal parameters such that:

$$E ( {λ}_{t + δ t}^{*} , t + δ t ) = {min}_{λ} E ( λ , t + δ t ) .$$

Since the Lipschitz constant L(t)≤ [symbol] (poly(N)) (assumption (A4)) and ∥λₜ−λ_{t+δt}*∥²≤ [symbol] (poly(N)) (assumption (A6)), one can take

$${N}_{train} ( t + δ t ) = 𝒪 ( \frac{poly ( N )}{ϵ g ( t + δ t )} ) , \qquad ( 33 )$$

with a suitable [symbol] (1) prefactor, so that:

$$E ( {\tilde{λ}}_{t} , t + δ t ) - {min}_{λ} E ( λ , t + δ t ) < \frac{ϵ g ( t + δ t )}{4} .$$

Moreover, by assuming that the variational wave function is expressive enough (assumption (A7)), i.e.,

$${min}_{λ} E ( λ , t + δ t ) - {E}_{G} ( t + δ t ) < \frac{ϵ g ( t + δ t )}{4} ,$$

the researchers can then deduce, by taking λ_{t+δt}≡\tilde{λ}ₜ and summing the two previous inequalities, that:

$$E ( {λ}_{t + δ t} , t + δ t ) - {E}_{G} ( t + δ t ) < \frac{ϵ g ( t + δ t )}{2} .$$

Let the researchers recall that in step 1, the researchers have to initially prepare the variational ansatz to satisfy condition (28) at t=0. In fact, the researchers can take advantage of the assumption (A4), where the gradients are L(0)-Lipschitz with L(0)≤ [symbol] (poly(N)). The researchers can also use the convexity assumption (A8), and the researchers can show that a sufficient number of gradient descent steps to satisfy condition (30) at t=0 is estimated as:

$${N}_{warmup} ≡ {N}_{train} ( 0 ) = 𝒪 ( \frac{poly ( N )}{ϵ g ( 0 )} ) .$$

The latter can be obtained in a similar way as in Eq. (33).

In conclusion, the total number of gradient steps Nₛₜₑₚₛ to evolve the Hamiltonian Ĥ(0) to the target Hamiltonian Ĥ(1), while verifying the condition (28) is given by:

$${N}_{steps} = {\sum }_{n = 1}^{{N}_{annealing} + 1} {N}_{train} ( {t}_{n} ) ,$$

where each Nₜᵣₐᵢₙ(tₙ) satisfies the requirement (33). The annealing times {tₙ}ₙ₌₁^{N}^{_{annealing}}⁺¹ are defined such that t₁≡0 and tₙ₊₁≡tₙ+δtₙ. Here, δtₙ satisfies

$$δ {t}_{n} = 𝒪 ( \frac{ϵ g ( {t}_{n} )}{poly ( N )} ) .$$

The researchers also consider N_{annealing} the smallest integer such that t_{N}_{_{annealing}}+δt_{N}_{_{annealing}}≥1, in this case, the researchers define t_{N}_{_{annealing}}⁺¹≡1, indicating the end of annealing. Thus, N_{annealing} is the total number of annealing steps. Taking this definition into account, then one can show that

$${N}_{annealing} \leq \frac{1}{{min}_{\{ {t}_{n} \}} ( δ {t}_{n} )} + 1.$$

Using Eqs. (31) and (33) and the previous inequality Nₛₜₑₚₛ can be bounded from above as:

$${N}_{steps} \leq ( {N}_{annealing} + 1 ) {max}_{\{ {t}_{n} \}} ( {N}_{train} ( {t}_{n} ) ) \leq ( \frac{1}{{min}_{\{ {t}_{n} \}} ( δ {t}_{n} )} + 2 ) {max}_{\{ {t}_{n} \}} ( {N}_{train} ( {t}_{n} ) ) \leq 𝒪 ( \frac{poly ( N )}{{ϵ}^{2} {min}_{\{ {t}_{n} \}} {( g ( {t}_{n} ) )}^{2}} ) ,$$

where the transition from line 2 to line 3 is valid for a sufficiently small ∈ and min_{{t}_{ₙ}^{}}(g(tₙ)) . Furthermore, Nₛₜₑₚₛ can also be bounded from below as:

$${N}_{steps} \geq {max}_{\{ {t}_{n} \}} ( {N}_{train} ( {t}_{n} ) ) = 𝒪 ( \frac{poly ( N )}{ϵ {min}_{\{ {t}_{n} \}} ( g ( {t}_{n} ) )} ) .$$

Note that the minimum in the previous two bounds are taken over all the annealing times tₙ where 1≤n≤N_{annealing}+1.

In this derivation of the bound on Nₛₜₑₚₛ, the researchers have assumed that the ground state of Ĥtarget is non-degenerate, so that the gap does not vanish at the end of annealing (i.e., t=1). In the case of degeneracy of the target ground state, the researchers can define the gap g(t) by considering the lowest energy level that does not lead to the degenerate ground state.

It is also worth noting that the assumptions of this derivation can be further expanded and improved. In particular, the gradients of E(λ, t) are computed stochastically (see the Methods section), as opposed to the assumption (A4) where the gradients are assumed to be known exactly. To account for noisy gradients, it is possible to use convergence bounds of stochastic gradient descent to estimate a bound on the number of gradient descent steps. Second-order optimization methods such as stochastic reconfiguration/natural gradient can potentially show a significant advantage over first-order optimization methods, in terms of scaling with the minimum gap of the time-dependent Hamiltonian Ĥ(t)

Appendix C: Additional Results

In this section, the researchers provide additional results connected with the EA and fully connected models previously described.

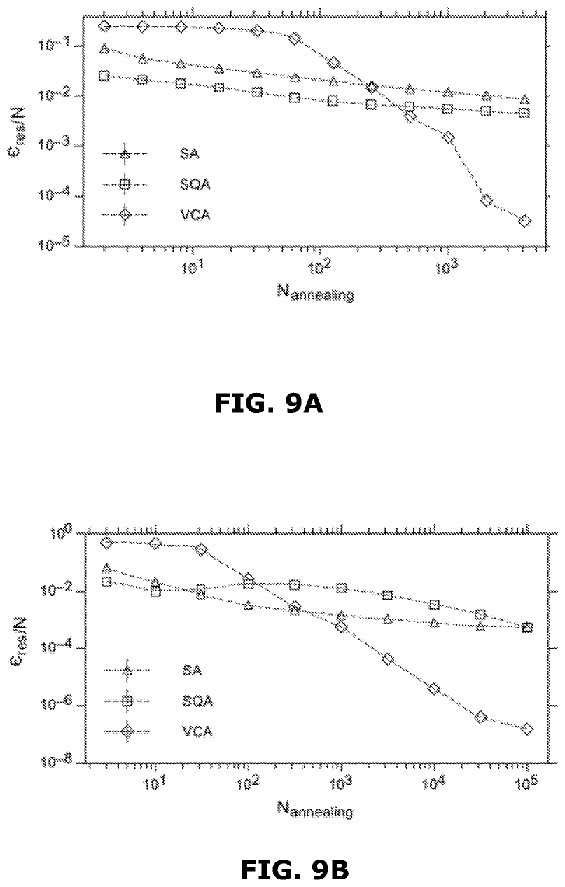

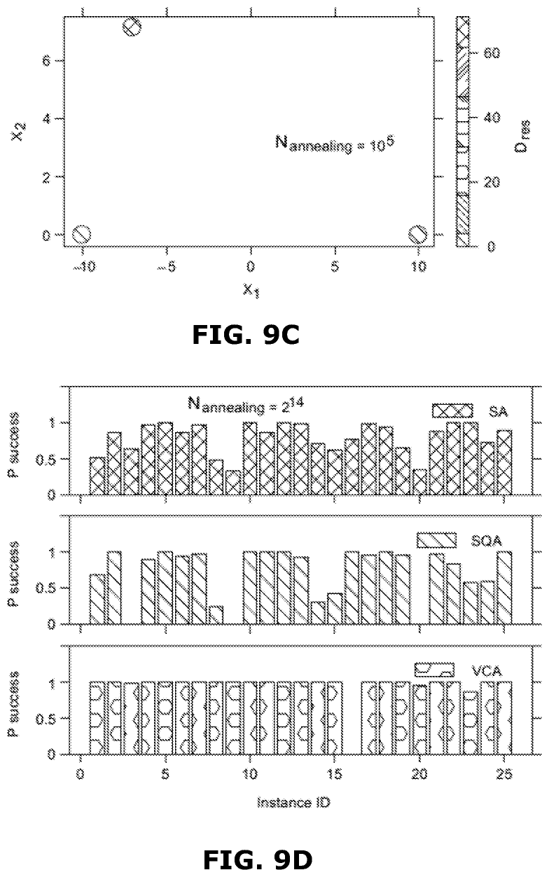

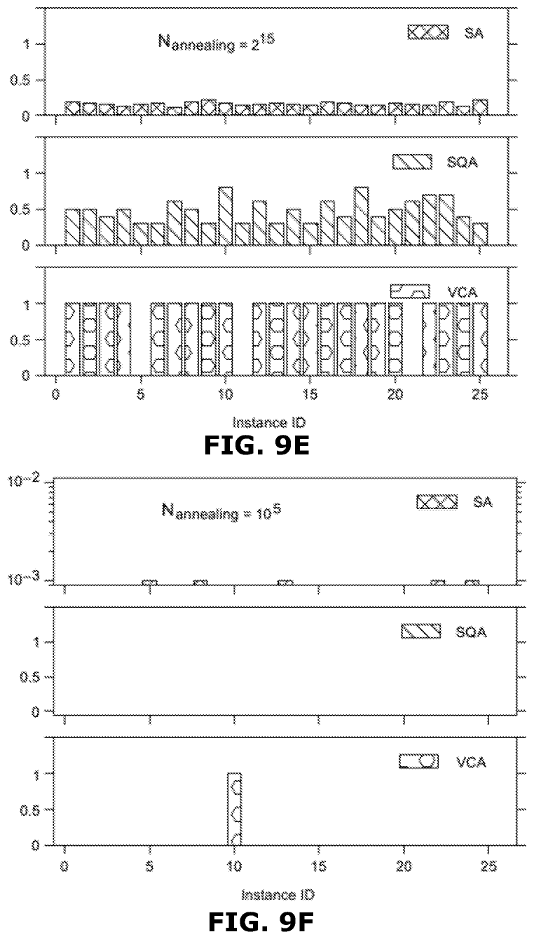

FIG. 9A shows a comparison between SA, SQA and VCA on a single instance of the EA model with system size (60×60). 1000 independent runs are performed for SA and, 50 annealing runs for SQA to estimate error bars. For VCA, the researchers estimate error bars using 10⁶ configurations obtained from the RNN at the end of annealing.

In FIG. 9A, the researchers provide additional evidence that VCA is superior to SA and SQA on a larger system size compared to FIG. 4C for the EA model. Here, the researchers do the comparison for a system size 60×60. The researchers use a single disorder realization to avoid extra computational resources. In this case, the residual energy ∈ᵣₑₛ is defined

∈ᵣₑₛ= [symbol] Ĥ [symbol] −E_{G}, (34)

where [symbol] . . . [symbol] is the arithmetic mean over the different runs for SA and SQA and over the samples obtained at the end of annealing from the RNN in the VCA protocol. The results in FIG. 9A illustrates that VCA is still superior, in terms of the average residual energy, to SA and SQA for the range of N_{annealing} shown in the plot.

FIG. 9B shows a similar comparison as in FIG. 9A on a single realization of the SK model with N=100 spins.

In FIG. 9B, the researchers show a comparison between SA, SQA and VCA on the SK model with N=100 spins. Similarly to FIG. 6A, the researchers do the same comparison, but for an order of magnitude larger N_{annealing}. Here, The researchers use a single instance to avoid using excessive compute resources. The researchers use the same definition of Eᵣₑₛ in Eq. (34). Similarly to the conclusion of FIG. 6A, the researchers still see that VCA provides more accurate solutions on average compared to SA and SQA.

FIG. 9C shows a plot of the two principal components after performing principal component analysis (PCA) on 50000 configurations obtained from the RNN, at the end of VCA protocol when applied to the SK model with N=100 spins as in FIG. 9B for N_{annealing}=10⁵. The color bar represents the distance Dᵣₑₛ defined in Eq. (35), from the two ground state configurations.

To show the advantage of autoregressive sampling of RNNs, the researchers perform PCA on the samples obtained from the RNN at the end of annealing after N_{annealing}=10⁵ steps. The researchers obtain the results in FIG. 9C. Interestingly, the researchers observe that the RNN recovers the two ground state configurations ±σ* as demonstrated by the two clusters at X₂=0. Here, the researchers define the distance of a configuration a from the two ground states ±σ* as

Dᵣₑₛ=\sqrt{∥σ−σ*∥₁∥σ+σ*∥₁,} (35)

that the researchers represent in the color bar of FIG. 9C, where ∥.∥₁ is the L₁ norm. These observations show that RNNs are indeed capable of capturing and sampling multiple modes, as opposed to Markov-chain Monte Carlo methods where sampling multiple modes at very low temperatures is often a challenging task when studying spin-glass models.

The researchers finally demonstrate a detailed analysis of the results of FIGS. 9D, 9E and 9F. FIGS. 9D, 9E and 9F display the probability of success on the 25 instances of the SK and WPE models used respectively in FIGS. 6D, 6E and 6F. Each probability of success P_{success} is computed using 1000 data points. Here, the researchers provide the probabilities of success for each instance configuration that the researchers attempt to solve using SA, SQA and VCA. The researchers note that the probability of success is computed as the ratio of the obtained ground states over the total number of configurations that are obtained for each method.

The results for SK (N=100 spins) are shown in FIG. 9D, where it is clear that the RNN provides a very high probability of success compared to SA and SQA on the majority of instances. The researchers observe the same behavior for WPE (α=0.5 and N=32 spins) in FIG. 9E. It is worth noting that VCA is not successful at solving a few instances, which could be related to the need to increase N annealing or to the need to improve the training scheme or representational power of dilated RNNs. Finally, in FIG. 9F, the researchers see that WPE (α=0.5 and N=32 spins) is indeed a challenging system for all the methods considered in this work. Interestingly, the researchers see that VCA manages to get a very high probability of success on one instance, while failing at solving the other instances. Furthermore, the researchers note that SQA was not successful for all the instances, while SA succeeds at finding the ground state for 5 instances with a low probability of success 10⁻³.

Appendix D: Running time

In this section, the researchers present a summary of the running time estimations for VCA, SA, and SQA, which are shown in Table I below.

TABLE I
A summary of the running times of SA, SQA and VCA performed in the
EA and Fully Connected Spin Glass sections above. The iteration
time for VCA is estimated as the time it takes to estimate
the free energy and to compute and apply its gradients to the RNN
parameters. For SA and SQA, it is estimated as the time it
takes to complete one Monte Carlo step multiplied by the
number of annealing runs. The values reported in this table
are highly dependent on numerical implementations,
hyperparameters and the devices the
researchers used in the simulations.

| | | Number of |
|---|---|---|
| Model | Method | iterations per second |
| Edwards-Anderson | SA (25 annealing | ~120 |
| (N = 40 × 40) | runs) | |
| (cf. FIG. 4C) | SQA (25 annealing | ~2.4 |
| | runs) | |
| | VCA (25 samples) | ~1.1 |
| SK (N = 100) (cf. FIG. 6A) | SA (50 annealing | ~290 |
| | runs) | |
| | SQA (50 annealing | ~1.4 |
| | runs) | |
| | VCA (50 samples) | ~5 |
| Wishart (N = 32, α = 0.5) | SA (50 annealing | ~1160 |
| (cf. FIG. 6B) | runs) | |
| | SQA (50 annealing | ~4.6 |
| | runs) | |
| | VCA (50 samples) | ~18.5 |

Appendix E: Hyperparameters

In this appendix, the researchers summarize the architectures and the hyperparameters of the simulations performed in this paper, as shown in Table II below. The latter has shown to yield good performance, while the researchers believe that a more advanced study of the hyperparameters can result in optimal results. The researchers also note that in this paper, VQA and VCA were run using a single GPU workstation for each simulation, while SQA and SA were performed in serial on a multi-core CPU.

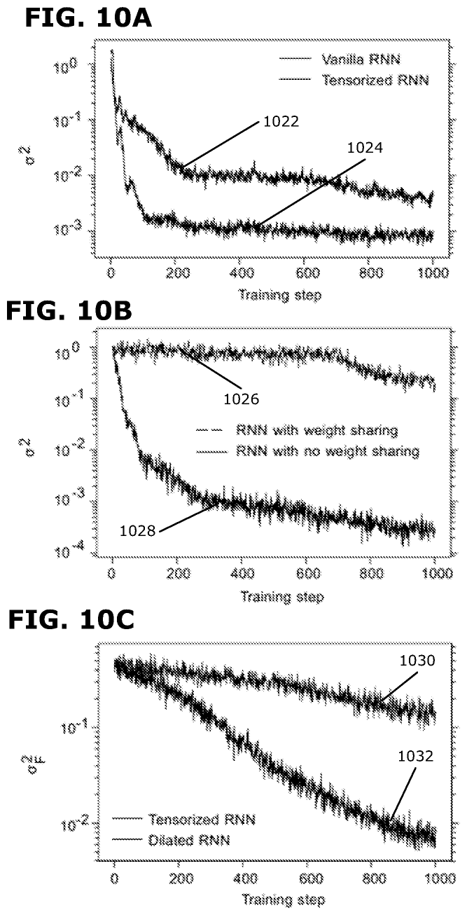

TABLE II
Hyperparameters used to obtain the results reported in this paper.
Note that the number of samples stands for
the batch size used to train the RNN.

| FIGS. | Parameter | Value |
|---|---|---|
| FIGS. 3 | Architecture | Tensorized RNN |
| and 8 | | wave function |
| | | with no-weight sharing |
| | Number of memory units | dₕ = 40 |
| | Number of samples | Nₛ = 50 |
| | Initial magnetic field | Γ₀ = 2 |
| | for VQA | |
| | Initial temperature | T₀ = 1 |
| | for VCA | |
| | Learning rate | η = 5 × 10⁻⁴ |
| | Warmup steps | N_{warmup} = 1000 |
| | Number of random | N_{instances} = 25 |
| | instances | |
| FIG. 4, | Architecture | 2D tensorized RNN |
| FIG. 9A | | wave function |
| | | with no weight-sharing |
| | Number of memory units | dₕ = 40 |
| | Number of samples | Nₛ = 25 |
| | Initial magnetic field | Γ₀ = 1 (for SQA, VQA |
| | | and RVQA) |
| | Initial temperature | T₀ = 1 (for SA, VCA |
| | | and RVQA) |
| | Learning rate | η = 10⁻⁴ |
| | Number of warmup steps | N_{warmup} = 1000 for 10 × 10 |
| | | N_{warmup} = 2000 for 40 × 40 |
| | | N_{warmup} = 5000 for 60 × 60 |
| | Number of random | N_{instances} = 25 for FIG. 4, |
| | instances | N_{instances} = 1 for FIG. 9A |
| FIGS. 6A, | Architecture | Dilated RNN wave function |
| 6D and | | with no weight-sharing |
| FIG. 9B | Number of memory units | dₕ = 40 |
| | Number of samples | Nₛ = 50 |
| | Initial temperature | T₀ = 2 (for SA and VCA) |
| | Initial magnetic field | Γ₀ = 2 (for SQA) |
| | Learning rate | η = 10⁻⁴ |
| | Number of warmup steps | N_{warmup} = 2000 |
| | Number of random | N_{instances} = 25 for |
| | instances | FIGS. 6A, 6D, |
| | | N_{instances} = 1 for FIG. 9B |
| FIGS. 6B, | Architecture | Dilated RNN wave function |
| 6C, 6E, 6F | | with no weight-sharing |
| | Number of memory units | dₕ = 20 |
| | Number of samples | Nₛ = 50 |
| | Initial temperature | T₀ = 1 (for SA and VCA) |
| | Initial magnetic field | Γ₀ = 1 (for SQA) |
| | Learning rate | η = 10⁻⁴ |
| | Number of warmup steps | N_{warmup} = 1000 |
| | Number of random | N_{instances} = 25 |
| | instances | |
| FIG. 7 | Architecture | Tensorized RNN |
| | | wave function |
| | | with weight sharing |
| | Number of memory units | dₕ = 20 |
| | Number of samples | Nₛ = 50 |
| | Initial temperature | T₀ = 2 |
| | Initial magnetic field | Γ₀ = 2 |
| | Learning rate | η = 10⁻³ |
| | Number of warmup steps | N_{warmup} = 1000 |
| FIGS. 10A, | Architecture | RNN wave function |
| 10B | Number of memory units | dₕ = 50 |
| | Number of samples | Nₛ = 50 |
| | Learning rate | η = 10⁻³ for FIG. 10A and |
| | | η = 5 × 10⁻⁴ for FIG. 10B |
| FIG. 10C | Architecture | RNN wave function with |
| | | no-weight sharing |
| | Number of memory units | dₕ = 20 |
| | of dilated RNN | |
| | Number of memory units | dₕ = 40 |
| | of tensorized RNN | |
| | Number of samples | Nₛ = 100 |
| | Learning rate | η = 10⁻⁴ |

Appendix F: Benchmarking Recurrent Neural Network Cells

To show the advantage of tensorized RNNs over vanilla RNNs, the researchers benchmark these architectures on the task of finding the ground state of the uniform ferromagnetic Ising chain (i.e., J_{i,j+1}=1) with N=100 spins at the critical point (i.e., no annealing is employed). Since the couplings in this model are site-independent, the researchers choose the parameters of the model to be also site-independent. FIGS. 10A-C shows energy (or Free energy) variance per spin α² vs the number of training steps.

In FIG. 10A, the researchers plot the energy variance per site σ² (see Eq. (24)) against the number of gradient descent steps, showing curves for a vanilla RNN 1022 and a tensorized RNN 1024. Here σ² is a good indicator of the quality of the optimized wave function. The results show that the tensorized RNN wave function can achieve both a lower estimate of the energy variance and a faster convergence.

FIG. 10A compares tensorized and vanilla RNN ansatzes both with weight sharing across sites on the uniform ferromagnetic Ising chain at the critical point with N=100 spins.

For the disordered systems studied in this paper, the researchers set the weights Tₙ, Uₙ and the biases bₙ, cₙ (in Eqs. (16) and (17)) to be site-dependent. To demonstrate the benefit of using site-dependent over site-independent parameters when dealing with disordered systems, the researchers benchmark both architectures on the task of finding the ground state of the disordered Ising chain with random discrete couplings J_{i,i+1}=±1 at the critical point, i.e., with a transverse field ┌=1. The researchers show the results in FIG. 10B and find that site-dependent parameters lead to a better performance in terms of the energy variance per spin.

FIG. 10B compares a tensorized RNN with and without weight sharing, trained to find the ground state of the random Ising chain with discrete disorder (J_{i,i+1}=±1) at criticality with N=20 spins, showing curves for a RNN with weight sharing 1026 and a RNN with no weight sharing 1028.

Furthermore, the researchers equally show the advantage of a dilated RNN ansatz compared to a tensorized RNN ansatz. The researchers train both of them for the task of finding the minimum of the free energy of the Sherrington-Kirkpatrick model with N=20 spins and at temperature T=1, as explained in the Methods section. Both RNNs have a comparable number of parameters (66400 parameters for the tensorized RNN and 59240 parameters for the dilated RNN). Interestingly, in FIG. 10C, the researchers find that the dilated RNN supersedes the tensorized RNN with almost an order of magnitude difference in term of the free energy variance per spin defined in Eq. (21). Indeed, this result suggests that the mechanism of skip connections allows dilated RNNs to capture long-term dependencies more efficiently compared to tensorized RNNs.

FIG. 10C compares a tensorized RNN and dilated RNN ansatzes, both with no weight sharing, trained to find the Sherrington-Kirkpatrick model's equilibrium distribution with N=20 spins at temperature T=1, showing curves for a tensorized RNN 1030 and a dilated RNN 1032.

General Description of Example Method, Device, and Computer-Readable Medium Embodiments

The following section of the specification provides general, high-level descriptions of example embodiments of methods, devices, or computer-readable media implementing one or more of the variational annealing techniques described above.

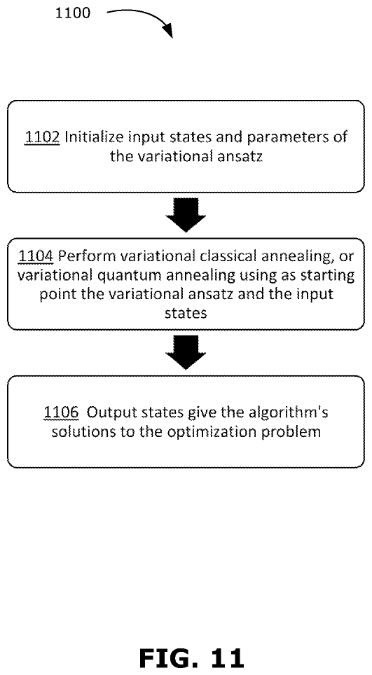

FIG. 11 is a flowchart of a variational annealing method 1100 for solving an optimization problem in silico. In different embodiments, method 1100 can be performed via a variational emulation of either simulated annealing (SA) or quantum annealing (QA). Both methods build upon variational principles of classical or quantum physics, as described above. More details on the theory can be found in “Solving Statistical Mechanics Using Variational Autoregressive Networks” by Dian Wu, Lei Wang, and Pan Zhang, https://doi.org/10.1103/PhysRevLett.122.080602 and, “Quantum Monte Carlo Approaches for Correlated Systems” by Federico Becca and Sandro Sorella https://doi.org/10.1017/9781316417041, both of which are incorporated herein by reference in their entirety.

Step 1102 generally corresponds to steps 302 and 304 of method 300, although some portions of steps 302 and/or 304 may be performed in step 1104 in some embodiments. At step 1102, input states are initialized, which is traditionally done randomly. However, some embodiments may encode a solution of the optimization problem, as described above. Additionally, at step 1102, the parameters of a user-defined variational ansatz are initialized. Method 1100 may accommodate a variety of ansatzes such as mean field models, tensor networks states, or neural networks states.

Some ansatzes from the latter category, namely autoregressive models, may provide certain advantages as described above, given their properties of being normalized and sampled from efficiently, in addition to being universal function approximators. Given that the autoregressive sampling generates uncorrelated samples, the sampling process can be performed in parallel. Ansatzes reflecting some properties of the optimization problem such as locality, connectivity or nonuniformity may achieve more accurate results in some embodiments, as described above.

For the classical case, the variational ansatz models the Boltzmann probability distribution of the classical system. For the quantum case, both positive and complex variational ansatzes, which represent the amplitude of a quantum wave function, can be supported. Note that complex ansatzes, which are used for encoding non-stoquastic drivers, can be used for variational quantum annealing (VQA) because the bedrock for this formulation is the Variational Monte Carlo method, the only Quantum Monte Carlo method which is naturally devoid of the infamous sign-problem. Using method 1100, certain optimization tasks whose dimension far exceeds what can be simulated using exact diagonalization techniques may be solved. The following reference depicts in detail the implementation of recurrent neural network ansatzes in a Variational Monte Carlo simulation “Recurrent neural network wave functions” by Mohamed Hibat-Allah, Martin Ganahl, Lauren E. Hayward, Roger G. Melko, and Juan Carrasquilla, https://doi.org/10.1103/PhysRevResearch.2.023358, which is incorporated herein by reference in its entirety.

In addition, the implementation of cutting-edge autoregressive models is readily available on various machine learning frameworks hence, enabling rapid testing with many advantages such as GPU or TPU acceleration. The example methods presented in this disclosure have been implemented by the researchers using the TensorFlow framework.

Step 1104 corresponds generally to one or more iterations of steps 306 and 308 of method 300. Step 1104 makes use of the previously described initialization procedure to perform either variational classical annealing or variational quantum annealing. In the former, the cost function found suitable is the variational free energy of the classical system. For this case, the normalized nature of autoregressive ansatzes was proved useful for the efficient estimation of the Von Neumann classical entropy. The variational energy was found to be suitable for the quantum case. However, some implementations of the quantum case use a fictitious variational free energy as a cost function. For this case, the annealing paradigm encodes both quantum fluctuations and fictitious thermal fluctuations that are varied according to a user-defined schedule. The duration of the annealing process can be used as a metric to end the simulations.

The output states obtained at the end of the annealing process (e.g., end step 2008 of FIG. 2A or 2058 or FIG. 2B) are output at step 1106 of method 1100 and give the solution to the optimization task generated by method 1100. Autoregressive ansatzes provide an added advantage at this step 1106 given that they can efficiently sample an arbitrary number of new solutions without suffering from strong autocorrelation effects that hamper ansatzes that do not have this property. Furthermore, their internal state can be stored of a later use to generate solutions on-demand, a possibility not available on traditional heuristics such as classical and quantum annealing.

In addition, an estimate of the number of solutions the optimization problem has can be obtained via an evaluation of the entropy at the end of annealing, a possibility not available on traditional heuristics such as classical and quantum annealing.

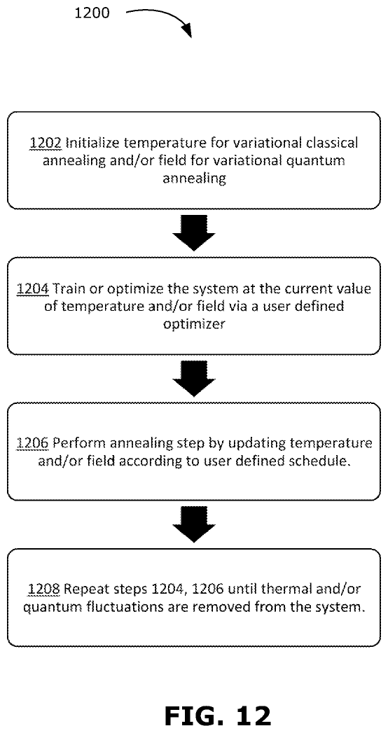

FIG. 12 is a flowchart of a method 1200 that illustrates in greater detail the variational implementations of classical and quantum annealing. Step 1202 corresponds generally to step 1104 of method 1100. At step 1102, the temperature and/or transverse field is initialized in various embodiments, depending on the variational annealing procedure used.

At step 1204, the system is trained or optimized at the current value of temperature and/or transverse field. Step 1204 corresponds generally to training step 308 of method 300; however, a first iteration of training step 1204 may be considered to correspond instead to warm-up step 304 of method 300. Training is performed by minimizing the cost function using a user-defined optimizer. Note that trainability of the cost function is an important factor that may determine the viability of example embodiments.

Once the system has converged to the set value of temperature and/or transverse field, annealing step 1206 is performed by updating the temperature and/or the field according to a user-defined annealing schedule. Step 1206 generally corresponds to annealing step 306 of method 300. Transfer learning of the ansatz parameters may be implemented in some embodiments to encode smoother annealing dynamics. In principle, the annealing dynamics could still be encoded with the ansatz's parameters (randomly) reinitialized between subsequent annealing steps 1206, albeit at a higher computational cost for the training step 1204.

At step 1208, steps 1204 and 1206 are applied iteratively until thermal and/or quantum fluctuations are removed from the system, or until some other convergence condition is satisfied, marking the end of the variational annealing process (e.g., annealing process end step 2008 or 2058). It will be appreciated that various convergence or other ending conditions can be used to determine when to stop the iteration of training steps 1204 and annealing steps 1206 in various embodiments.

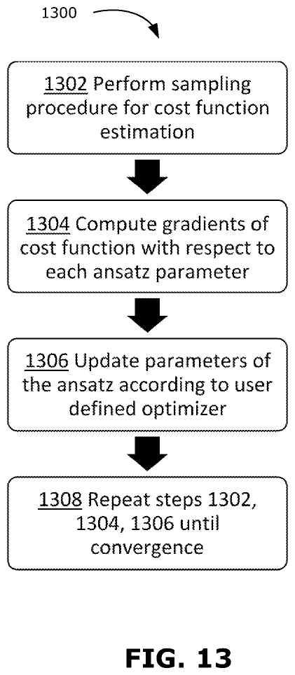

FIG. 13 is a flowchart showing steps of a method 1300 providing a detailed example of the training step 1204 of FIG. 12. Step 1302 is a sampling step that consists of generating uncorrelated samples from the variational ansatz. These samples are in turn used to estimate the cost function at hand.

At step 1304, partial derivatives of the cost function with respect to the ansatz parameters are computed. In the case of autoregressive ansatzes, properties of the computational graph are exploited so that gradients are computed efficiently using the automatic differentiation technique.

At step 1306, the parameters of the variational ansatz are updated using a user-defined optimizer. Note that the choice of the optimizer and its hyperparameters such as the learning rate and batch size affects the efficiency of the training process. For the methods used in this embodiment, the Adam optimizer has been used.

At step 1308, steps 1304 and 1306 are iteratively repeated until training reaches a desired level of convergence, or until some other training end condition is satisfied.

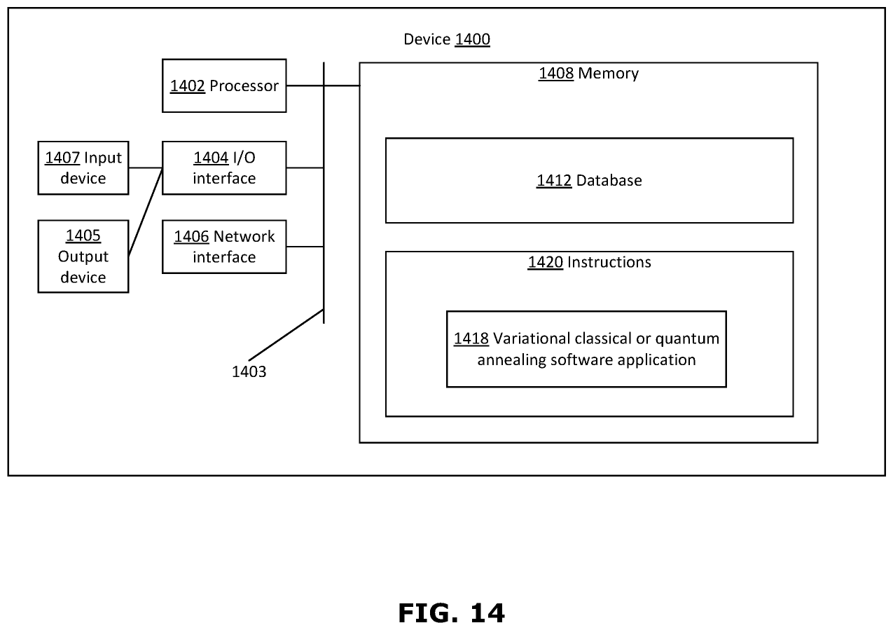

FIG. 14 shows a device 1400 configured to execute a variational classical or quantum annealing software application 1418 for performing one or more of the variational classical or quantum annealing methods described above, to solve optimization problems on a classical processing system (i.e., device 1400). In some examples, the device 1400 can be implemented as a distributed system on one or more classical computing devices in one or more locations, in which the methods described previously can be implemented.

Processor-readable instructions implementing the variational classical or quantum annealing software application 1418 are stored in a memory 1408, together with a database 1412 which may include different instances of the optimization problem being solved. The memory 1408 in turn interacts with the I/0 interface 1404, which is connected to input devices 1407 and output devices 1405. The device 1400 mediates classical information processing amongst a processor 1402, the memory 1408, the I/0 interface 1404, and a network interface 1406, with communication therebetween enabled by a data bus 1403.

In various example embodiments, the variational classical or quantum annealing software application 1418 may include various functional software modules, such as a training module for performing the training steps, an annealing module for performing the annealing steps, and a machine learning (ML) model used as the variational ansatz. In some embodiments, the ML model may be a recurrent cell such as a gated recurrent unit (GRU) cell, a long short-term memory (LSTM) cell, or a vanilla (i.e., conventional) RNN cell, that is unrolled on the coordinate system of the optimization problem (for example, a lattice site for a spin glass). Several RNN cells can be stacked at the same site to increase the representational capacity of the neural network. The autoregressive step can include nearest neighbouring sites or sites far away using, for example, skipped connection. This can help to increase the representational capacity of the network if, for example, the optimization problem includes long-range connections. Weight sharing or non-weight sharing across the cells at different sites can be also implemented depending on the structure of the optimization problem (e.g., whether it includes randomness or glassiness). The variational classical or quantum annealing software application 1418 may also define the cost function (i.e. loss function) as described above.

The database 1412 can include additional data, such as a training dataset. In some embodiments, the training dataset includes a string of bits that encodes the coordinate system of the optimization problem, for example, a lattice site for a spin glass, a conformation coordinates for a protein, or a historical path for a portfolio optimization problem.

Although example embodiments may describe methods and processes with steps in a certain order, one or more steps of the methods and processes may be omitted or altered as appropriate. One or more steps may occur in an order other than that in which they are described, as appropriate.

Although example embodiments may be described, at least in part, in terms of methods, a person of ordinary skill in the art will understand that example embodiments can also be directed to the various components for performing at least some of the aspects and features of the described methods, be it by way of hardware components, software or any combination of the two. Accordingly, the technical solution of example embodiments may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

Example embodiments may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of example embodiments.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method for providing a solution to an optimization task using a variational emulation of annealing, the solution comprising a plurality of values for a respective plurality of parameters, the method comprising:
obtaining a plurality of initial input values;
obtaining a variational ansatz comprising a plurality of initial values for the plurality of parameters; and
repeating one or more times:
performing an annealing step while maintaining the values of the plurality of parameters; and
performing a training step to modulate the values of the plurality of parameters according to a cost function, thereby generating a plurality of trained values of the respective plurality of parameters, the plurality of trained values having a lower cost, according to the cost function, than a cost of the values of the plurality of parameters prior to the modulation.

2. The method of claim 1, wherein the annealing step comprises changing a temperature parameter of the cost function.

3. The method of claim 2, wherein:
the variational emulation of annealing is variational emulation of classical annealing; and
the cost function comprises a variational free energy function.

4. The method of claim 1, wherein the annealing step comprises changing a driving coupling of the cost function.

5. The method of claim 4, wherein:
the variational emulation of annealing is variational emulation of quantum annealing; and
the cost function comprises a variational energy function.

6. The method of claim 5, wherein positive wavefunctions ansatzes are used to implement stoquastic drivers.

7. The method of claim 5, wherein complex wavefunctions ansatzes are used to implement non-stoquastic drivers.

8. The method of claim 1, wherein the annealing step comprises:
changing a driving coupling of the ansatz; and
changing a fictitious temperature parameter of the ansatz.

9. The method of claim 1, wherein the variational ansatz comprises an autoregressive neural network.

10. The method of claim 9, wherein the autoregressive neural network encodes one or more of the following:
the locality of the optimization task;
the connectivity of the optimization task; and
the uniformity or nonuniformity of the optimization task.

11. The method of claim 1, further comprising:
estimating a number of solutions of the optimization problem by calculating a residual entropy.

12. The method of claim 1, wherein the training step comprises:
performing gradient descent on the plurality of parameters based on the cost function.

13. The method of claim 1, further comprising, after repeating the annealing step and training step one or more times:
storing the variational ansatz for future sampling.

14. The method of claim 13, wherein:
the variational ansatz comprises an autoregressive neural network; and
the future sampling comprises using the variational ansatz as an on-demand sampler for generating solutions of the optimization task.

15. The method of claim 13, wherein:
the variational ansatz comprises an autoregressive neural network; and
the future sampling comprises using the variational ansatz as an on-demand sampler for generating solutions of a different optimization task.

16. The method of claim 1, further comprising, after repeating the annealing step and training step one or more times:
using the values of the plurality of parameters as an input to train a neural network to perform an optimization task that the neural network was not previously trained to perform.

17. The method of claim 1, wherein the training step comprises:
setting a temperature parameter of the cost function to zero; and
setting a transverse field parameter of the cost function to zero.

18. The method of claim 1, wherein the variational ansatz comprises one of the following:
a mean field model;
a tensor network; or
a non-autoregressive artificial neural network.

19. The method of claim 18, wherein the variational ansatz encodes one or more of the following:
the locality of the optimization task;
the connectivity of the optimization task; and
the uniformity or nonuniformity of the optimization task.

20. A non-transitory computer readable medium storing instructions that, when executed by a processor of a device, cause the device to provide a solution to an optimization task using a variational emulation of annealing, the solution comprising a plurality of values for a respective plurality of parameters, by:
obtaining a plurality of initial input values;
obtaining a variational ansatz comprising a plurality of initial values for the plurality of parameters; and
repeating one or more times:
performing an annealing step while maintaining the values of the plurality of parameters; and
performing a training step to modulate the values of the plurality of parameters according to a cost function, thereby generating a plurality of trained values of the respective plurality of parameters, the plurality of trained values having a lower cost, according to the cost function, than a cost of the values of the plurality of parameters prior to the modulation.
